(19) United States
(12) Patent Application Publication
(10) Pub. No.: US 2025/0372878 A1
(43) Pub. Date: Dec. 4, 2025

(54) COMPACT BROADBAND ANTENNAS FOR WATER METER MODULES

(71) Applicant: Sensus Spectrum, LLC, Morrisville, NC (US)

(72) Inventors: Robert Davis, Covington, LA (US); Mohamed Khalifa, Durham, NC (US)

(21) Appl. No.: 19/226,294

(22) Filed: Jun. 3, 2025

Related U.S. Application Data
(60) Provisional application No. 63/655,727, filed on Jun. 4, 2024.

(51) Int. Cl. H01Q 9/30; H01Q 1/22; H01Q 5/307

(52) U.S. Cl. CPC H01Q 9/30; H01Q 1/2233; H01Q 5/307

(57) ABSTRACT

A compact broadband antenna system for a water meter module including a dual-band monopole antenna system having an elongated ground plane, spiral radiating elements that enable operation in a first frequency band, and patch radiating elements that enable operation in a second frequency band, separate from and higher than the first frequency band. The water meter module may include a water-tight enclosure to house the dual-band-monopole antenna system and other components.

### CROSS-REFERENCE TO RELATED APPLICATION

This application claims priority to and the benefit of U.S. Provisional Application No. 63/655,727 filed Jun. 4, 2024, the content of which is hereby incorporated herein in its entirety.

### FIELD

The present inventive concept relates generally to a compact broadband antenna system for a water meter module, e.g., a pit set module and, more specifically, to an antenna system that allows the water meter to operate over two distinct frequency bands for compatibility with emerging communication standards.

### BACKGROUND

In recent years, water utilities have moved toward the use of remote water meters in order to track water usage accurately, detect possible leaks, etc. These remote water meters eliminate the need for manual readings and can provide frequent and precise data.

One type of such a remote water meter is what is known as a “pit set” water meter module. A pit set water meter module is a type of water meter installation that involves placing the water meter and associated components inside an underground pit.

An example of a commercially-available pit set water meter module is the Sensus SmartPoint® 520M Pit Set Module. Existing Sensus SmartPoint® 520M Pit Set Modules are configured for FlexNet® system operation, which serves as a dedicated two-way communication path over a secure, relatively narrow frequency band (901-960 MHz). The FlexNet® system may allow for remote water management (e.g., turning service on/off remotely), on-demand water readings, leak detection, etc.

Water meters such as the Sensus SmartPoint® 520M Pit Set Module utilize monopole antennas. Monopole antennas are widely used in wireless communication systems due to their simplicity and versatility. A monopole antenna is a type of radio antenna that consists of a straight, often rod-shaped conductor mounted perpendicularly above a conductive surface, generally referred to as a ground plane. However, achieving dual-band operation with desirable characteristics in a monopole antenna remains a challenge. Existing solutions may compromise bandwidth, efficiency, or physical size.

### SUMMARY

In some embodiments of the present inventive concept, a dual-band monopole antenna system is provided including an elongated ground plane, spiral radiating elements for enabling operation in a first frequency band, and patch radiating elements for enabling operation in a second frequency band, separate from and higher than the first frequency band.

In further embodiments, the first frequency band may be 700 MHz to 960 Mhz and the second frequency band may be 1700 MHz to 2200 MHz.

In still further embodiments, the dual-band monopole antenna may be positioned in a water meter.

In some embodiments, the elongated ground plane may be formed by a printed circuit board.

In further embodiments, the printed circuit board may be T-shaped, and the elongated ground plane may be enhanced by the T-shaped printed circuit board.

In still further embodiments, the spiral radiating elements and the patch radiating elements may be top-loaded on the printed circuit board.

In some embodiments, the monopole antenna system may include a shared feed point on the printed circuit board for both the first frequency band and the second frequency band.

In further embodiments, the printed circuit board may be formed of FR4 fiberglass material.

In still further embodiments, the printed circuit board may be a multi-layer printed circuit board.

In some embodiments, the printed circuit board may be a four-layer printed circuit board.

In further embodiments, the monopole antenna system may include lumped tuning elements configured for impedance matching and resonance suppression.

In still further embodiments, the lumped tuning elements may include a series tuning inductor and tuning capacitor, and the series tuning inductor and tuning capacitor are configured to center the first frequency band of operation.

In some embodiments, the tuning capacitor may be further configured to couple the spiral radiating elements and the patch radiating elements on the printed circuit board.

In further embodiments, the lumped tuning elements include a series matching inductor, and the series matching inductor is configured to center the upper frequency band of operation.

Still further embodiments of the present inventive concept provide a water meter module. The water meter module includes an enclosure and a dual-band monopole antenna system sized and configured for placement within the enclosure. The dual-band monopole antenna system includes an elongated ground plane, spiral radiating elements enable operation in the first frequency band, and patch radiating elements that enable operation in a second frequency band, separate from and higher than the first frequency band.

In some embodiments, the first frequency band may be 700 MHz to 960 Mhz and the second frequency band may be 1700 MHz to 2200 MHz

In further embodiments, the elongated ground plane may be formed by a printed circuit board.

In still further embodiments, the printed circuit board may be T-shaped, and the elongated ground plane is enhanced by the T-shaped printed circuit board.

In some embodiments, the water meter module may also include a battery and a hybrid layer capacitor (HLC) coupled to the printed circuit board.

In further embodiments, the battery and HLC are positioned relative to the printed circuit board so as to form part of a ground system of the dual-band monopole antenna system.

In still further embodiments, the enclosure may be formed of a High-density polyethylene (HDPE) material.

In some embodiments, the water meter module may also include a plastic housing sized and configured to receive and substantially surround the enclosure.

### BRIEF DESCRIPTION OF THE DRAWINGS

FIG. 1 is a top view of an antenna on a printed circuit board according to some embodiments of the present inventive concept.

FIG. 2 is a bottom view of the antenna on a printed circuit board of FIG. 1 according to some embodiments of the present inventive concept.

FIG. 3 is a view of the antenna of FIGS. 1 and 2 looking through the top side of the printed circuit board according to some embodiments of the present inventive concept.

FIG. 4 is a view of the antenna of FIGS. 1 and 2 looking through the bottom side of the printed circuit board according to some embodiments of the present inventive concept.

FIG. 5 is a top side view of the antenna according to some embodiments of the present inventive concept shown in a printed circuit board with additional mechanical and electrical components in place and within an enclosure.

FIG. 6 is a bottom side view of the antenna according some embodiments of the present inventive concept shown in a printed circuit board with additional mechanical and electrical components in place and within an enclosure.

FIG. 7 is a top side view of the antenna of FIGS. 1 and 2 showing the location of a tuning capacitor according to some embodiments of the present inventive concept.

FIG. 8 is a bottom side view of the antenna of FIGS. 1 and 2 showing the location of tuning inductors and the antenna feed point according to some embodiments of the present inventive concept.

FIG. 9 is a perspective view of an enclosure for the water meter module according to some embodiments of the present inventive concept.

FIG. 10 is a bottom side view of the enclosure of FIG. 9 showing placement of the printed circuit board and additional mechanical and electrical components within the enclosure according to some embodiments of the present inventive concept.

FIG. 11 is a bottom side view of the enclosure of FIG. 9 with the bottom cover omitted and showing a battery, touch coupler, and hybrid layer capacitor (HLC) of the water meter module according to some embodiments of the present inventive concept.

FIG. 12 is a disassembled view of the enclosure of FIG. 9 with additional plastic housing hardware according to some embodiments of the present inventive concept.

FIG. 13 is an assembled view of the enclosure of FIG. 9 with the plastic housing and configured for water pit installation according to some embodiments of the present inventive concept.

FIG. 14 is a plot of surface current at 700 MHz as viewed from the top of the printed circuit board and looking through the printed circuit board according to some embodiments of the present inventive concept. according to some embodiments of the present inventive concept.

FIG. 15 is a plot of surface current at 700 MHz as viewed from the bottom of the printed circuit board and looking through the printed circuit according to some embodiments of the present inventive concept.

FIG. 16 is a plot of surface current at 850 MHz as viewed from the top of the printed circuit board and looking through the printed circuit board according to some embodiments of the present inventive concept.

FIG. 17 is a plot of surface current at 850 MHz as viewed from the bottom of the printed circuit board and looking through the printed circuit board according to some embodiments of the present inventive concept.

FIG. 18 is a plot of surface current at 960 MHz as viewed from the top of the printed circuit board and looking through the printed circuit board according to some embodiments of the present inventive concept.

FIG. 19 is a plot of surface current at 960 MHz as viewed from the bottom of the printed circuit board and looking through the printed circuit board according to some embodiments of the present inventive concept.

FIG. 20 is a plot of surface current at 1700 MHz as viewed from the top of the printed circuit board and looking through the printed circuit board according to some embodiments of the present inventive concept.

FIG. 21 is a plot of surface current at 1700 MHz as viewed from the bottom of the printed circuit board and looking through the printed circuit board according to some embodiments of the present inventive concept.

FIG. 22 is a plot of surface current at 1900 MHz as viewed from the top of the printed circuit board and looking through the printed circuit board according to some embodiments of the present inventive concept.

FIG. 23 is a plot of surface current at 1900 MHz as viewed from the bottom of the printed circuit board and looking through the printed circuit board according to some embodiments of the present inventive concept.

FIG. 24 is a plot of surface current at 2200 MHz as viewed from the top of the printed circuit board and looking through the printed circuit board according to some embodiments of the present inventive concept.

FIG. 25 is a plot of surface current at 2200 MHz as viewed from the bottom of the printed circuit board and looking through the printed circuit board according to some embodiments of the present inventive concept.

FIG. 26 is a plot showing antenna return loss (in dB) versus frequency (in GHz) according to some embodiments of the present inventive concept.

FIG. 27 is a plot showing simulated antenna efficiency versus frequency (in GHz) according to some embodiments of the present inventive concept.

FIG. 28 shows 3D antenna radiation at 700 MHz according to some embodiments of the present inventive concept.

FIG. 29 shows 3D antenna radiation at 850 MHz according to some embodiments of the present inventive concept.

FIG. 30 shows 3D antenna radiation at 960 MHz according to some embodiments of the present inventive concept.

FIG. 31 shows 3D antenna radiation at 1700 MHz according to some embodiments of the present inventive concept.

FIG. 32 shows 3D antenna radiation at 1900 MHz according to some embodiments of the present inventive concept.

FIG. 33 shows 3D antenna radiation at 2200 MHz according to some embodiments of the present inventive concept.

FIG. 34 is a top view of an antenna on a printed circuit board according to some embodiments of the present inventive concept.

FIG. 35 is a bottom view of the antenna on a printed circuit board of FIG. 34.

FIG. 36 is a view of the antenna of FIGS. 34 and 35 looking through the top side of the printed circuit board and showing the location of a tuning capacitor.

FIG. 37 is a view of the antenna of FIGS. 34 and 35 looking through the bottom side of the printed circuit board and showing the location of tuning inductors and the antenna feed point.

FIG. 38 is a plot of surface current at 700 MHz as viewed from the top of the printed circuit board and looking through the printed circuit board according to some embodiments of the present inventive concept.

FIG. 39 is a plot of surface current at 700 MHz as viewed from the bottom of the printed circuit board and looking through the printed circuit board according to some embodiments of the present inventive concept.

FIG. 40 is a plot of surface current at 850 MHz as viewed from the top of the printed circuit board and looking through the printed circuit board according to some embodiments of the present inventive concept.

FIG. 41 is a plot of surface current at 850 MHz as viewed from the bottom of the printed circuit board and looking through the printed circuit board according to some embodiments of the present inventive concept.

FIG. 42 is a plot of surface current at 960 MHz as viewed from the top of the printed circuit board and looking through the printed circuit board according to some embodiments of the present inventive concept.

FIG. 43 is a plot of surface current at 960 MHz as viewed from the bottom of the printed circuit board and looking through the printed circuit board according to some embodiments of the present inventive concept.

FIG. 44 is a plot of surface current at 1700 MHz as viewed from the top of the printed circuit board and looking through the printed circuit board according to some embodiments of the present inventive concept.

FIG. 45 is a plot of surface current at 1700 MHz as viewed from the bottom of the printed circuit board and looking through the printed circuit board according to some embodiments of the present inventive concept.

FIG. 46 is a plot of surface current at 1900 MHz as viewed from the top of the printed circuit board and looking through the printed circuit board according to some embodiments of the present inventive concept.

FIG. 47 is a plot of surface current at 1900 MHz as viewed from the bottom of the printed circuit board and looking through the printed circuit board according to some embodiments of the present inventive concept.

FIG. 48 is a plot of surface current at 2200 MHz as viewed from the top of the printed circuit board and looking through the printed circuit board according to some embodiments of the present inventive concept.

FIG. 49 is a plot of surface current at 2200 MHz as viewed from the bottom of the printed circuit board and looking through the printed circuit board according to some embodiments of the present inventive concept.

FIG. 50 is a plot showing antenna return loss (in dB) versus frequency (in GHz) according to some embodiments of the present inventive concept.

FIG. 51 is a plot showing simulated antenna efficiency versus frequency (in GHz) according to some embodiments of the present inventive concept.

FIG. 52 shows 3D antenna radiation at 700 MHz according to some embodiments of the present inventive concept.

FIG. 53 shows 3D antenna radiation at 850 MHz according to some embodiments of the present inventive concept.

FIG. 54 shows 3D antenna radiation at 960 MHz according to some embodiments of the present inventive concept.

FIG. 55 shows 3D antenna radiation at 1700 MHz according to some embodiments of the present inventive concept.

FIG. 56 shows 3D antenna radiation at 1900 MHz according to some embodiments of the present inventive concept.

FIG. 57 shows 3D antenna radiation at 2200 MHz according to some embodiments of the present inventive concept.

FIG. 58 shows the ground plane of an antenna relative to a printed circuit board according to some embodiments of the present inventive concept.

FIG. 59 shows a top view plot of surface currents on an antenna ground plane and radiator at 700 MHz according to some embodiments of the present inventive concept.

FIG. 60 shows a bottom view plot of surface currents on an antenna ground plane and radiator at 700 MHz according to some embodiments of the present inventive concept.

FIG. 61 shows a bottom perspective view plot of surface currents on an antenna ground plane and radiator at 700 MHz according to some embodiments of the present inventive concept.

FIG. 62 shows a top view plot of surface currents on an antenna ground plane and radiator at 1900 MHz according to some embodiments of the present inventive concept.

FIG. 63 shows a bottom view plot of surface currents on an antenna ground plane and radiator at 1900 MHz according to some embodiments of the present inventive concept.

FIG. 64 shows a bottom perspective view plot of surface currents on an antenna ground plane and radiator at 1900 MHz according to some embodiments of the present inventive concept.

FIG. 65 shows a bottom perspective view plot of antenna surface currents and corresponding antenna gain at 700 MHz according to some embodiments of the present inventive concept.

FIG. 66 shows a bottom perspective view plot of antenna surface currents and corresponding antenna gain at 1900 MHz according to some embodiments of the present inventive concept.

### DESCRIPTION OF EMBODIMENTS

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

As discussed above, current water meters such as the Sensus SmartPoint® 520M Pit Set Modules are configured for FlexNet® system operation, which serves as a dedicated two-way communication path over a secure, relatively narrow frequency band (901-960 MHz). While effective for many applications, the dedicated frequency band limits use with other systems utilizing, e.g., 3^{rd} Generation Partnership Project (3GPP) long term evolution (LTE) standards including (but not limited to) Narrow Band Internet of Things (i.e., NBioT), Category “M” (i.e., Cat-M), and standard cellular services.

Embodiments of the present inventive concept provide a compact, broadband antenna for use in, for example, a water meter module having substantially the same or similar footprint as, e.g., an existing Sensus SmartPoint® 520M Pit Set Module, while allowing the module to operate over dual-band frequency ranges of, e.g., 700-960 MHz and 1700-2200 MHz, which are frequencies allocated for 3GPP LTE system operation worldwide. In this way, the present inventive concept may enable the retrofit of existing Sensus SmartPoint® 520M Pit Set Modules configured for FlexNet® system operation (i.e., 901-960 MHz bandwidth operating range), and/or utilizing existing plastic and mechanical tooling for such modules, but providing an antenna for operation as, e.g., NBioT and Cat-M LTE systems. As such, the present inventive concept may greatly reduce or, possibly, eliminate retooling cost, thereby allowing expedited time-to-market of newer LTE systems by forgoing the need to produce new tooling for plastic enclosures and device mounting.

Although intended for use in pit set module applications in some embodiments, it is to be understood that the present inventive concept is not limited to such applications and may be utilized for other water meter applications. In fact, in some embodiments, the present inventive concept may be configured for use outside of water meter applications.

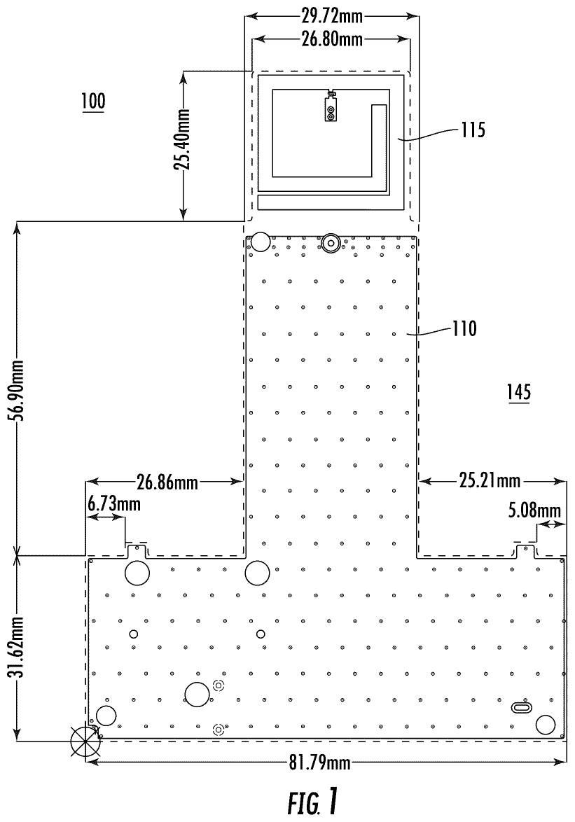

FIGS. 1-8 illustrate various views of a compact, broadband antenna in accordance with some embodiments of the present inventive concept. The antenna illustrated in these figures is a monopole antenna having an elongated ground plane. As discussed above, monopole antennas are widely used in wireless communication systems due to their simplicity and versatility. A monopole antenna is a type of radio antenna that consists of a straight, often rod-shaped conductor mounted perpendicularly above a conductive surface, generally referred to as a ground plane. However, achieving dual-band operation with desirable characteristics in a monopole antenna remains a challenge.

Accordingly, some embodiments provide an antenna that is top loaded with spiral and/or patch radiating elements which, when combined with lumped tuning elements, enable the production of two distinct bands of operation. In some embodiments, the first band of operation occupies a bandwidth of 700 MHz to 960 MHz, while the second band of operation occupies a frequency range of 1700 MHz to 2200 MHz. As discussed previously, these two band ranges are frequencies allocated for 3GPP LTE system operation worldwide. However, it is to be understood that the present inventive concept is not limited to the above bandwidth ranges, and other bandwidths are possible for the first and/or second bands without departing from the scope of the present inventive concept.

As used herein, a “pit set” water meter module refers to a type of water meter installation that involves placing the water meter and associated components inside an underground pit. Although embodiments of the present inventive concept are discussed with respect to pit set water meters as an example, embodiments of the present inventive concept are not limited thereto.

The various views of a water meter module printed circuit board (PCB) and/or antenna configuration in accordance with some embodiments of the present inventive concept will now be discussed with respect to FIGS. 1-8.

Referring first to FIG. 1, a top view of an antenna 100 in accordance with some embodiments of the present inventive concept will be discussed. As illustrated, the antenna 100 includes an elongated ground plane 110; spiral radiating elements 115 and patch radiating elements 120. The spiral radiating elements 115 enable production a first frequency band of operation. Similarly, the patch radiating elements enable production of a second frequency band of operation, separate from and higher than the first frequency band. In some embodiments, the antenna 100 may be constructed on a flame retardant class 4 (FR4) printed circuit board. However, it will be understood that embodiments of the present inventive concept are not limited to this material and that any suitable material may be used without departing from the scope of the present inventive concept.

As used herein, FR4 refers to a composite material used in printed circuit board (PCB) manufacturing. It is a glass-reinforced epoxy laminate, made of woven fiberglass cloth bound together with an epoxy resin.

Furthermore, the dimensions illustrated in FIGS. 1-8 in mm are provided as example dimensions only and, therefore, embodiments of the antenna system are not limited thereto. The dimensions can be scaled up or down without departing from the scope of the present inventive concept.

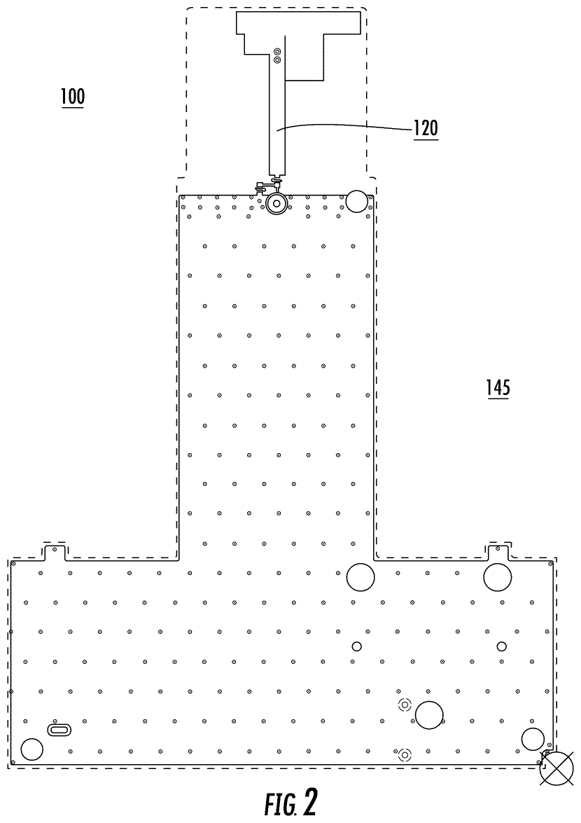

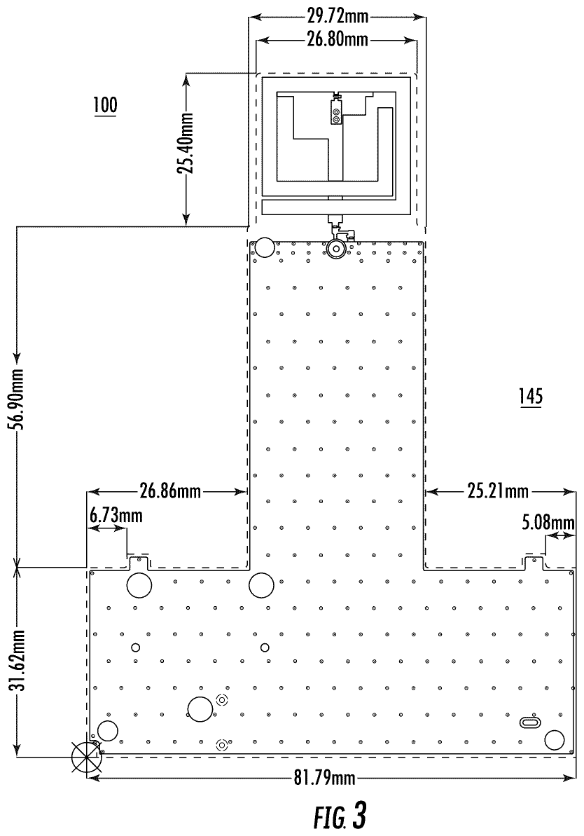

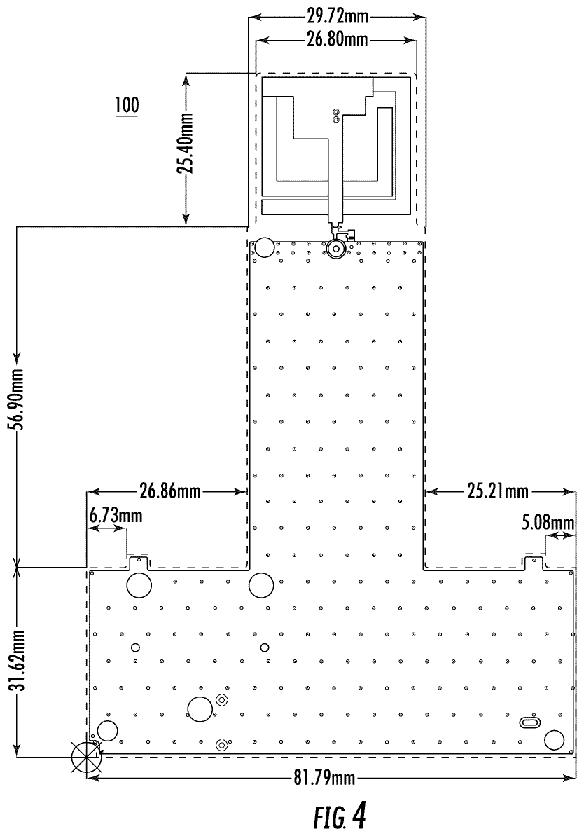

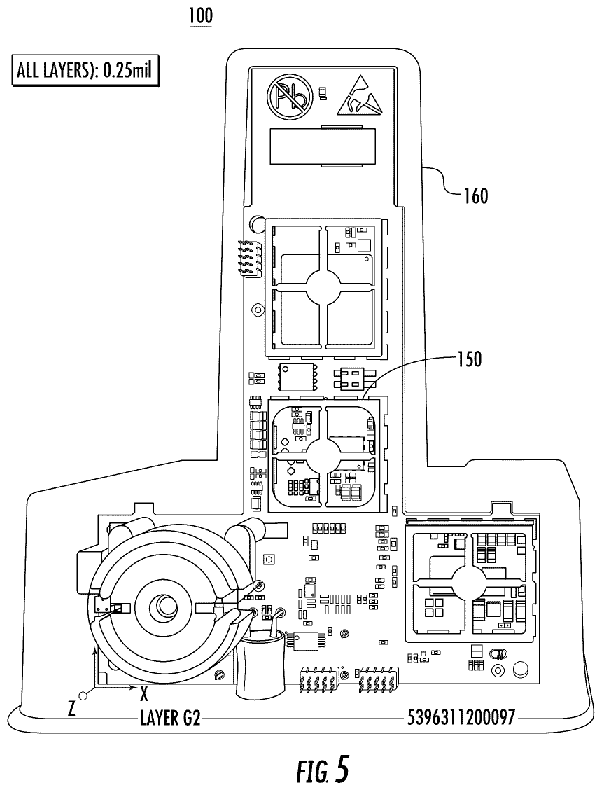

FIG. 2 illustrates a bottom view of the antenna 100 of FIG. 1 in accordance with embodiments discussed herein. FIG. 3 illustrates the antenna 100 of FIGS. 1 and 2 with the view looking through the PCB from the top side of the PCB. FIG. 4 illustrates the antenna of FIGS. 1-3 with the view looking through the PCB from the bottom side of the PCB. FIG. 5 illustrates a top side view of the antenna 100 of FIGS. 1-4, along with the electrical and mechanical components 150 and a housing 160 of a pit set module, for example, the Sensus SmartPoint® 520M Pit Set Module, in place. The antenna top loading area is shown at the top of the figure.

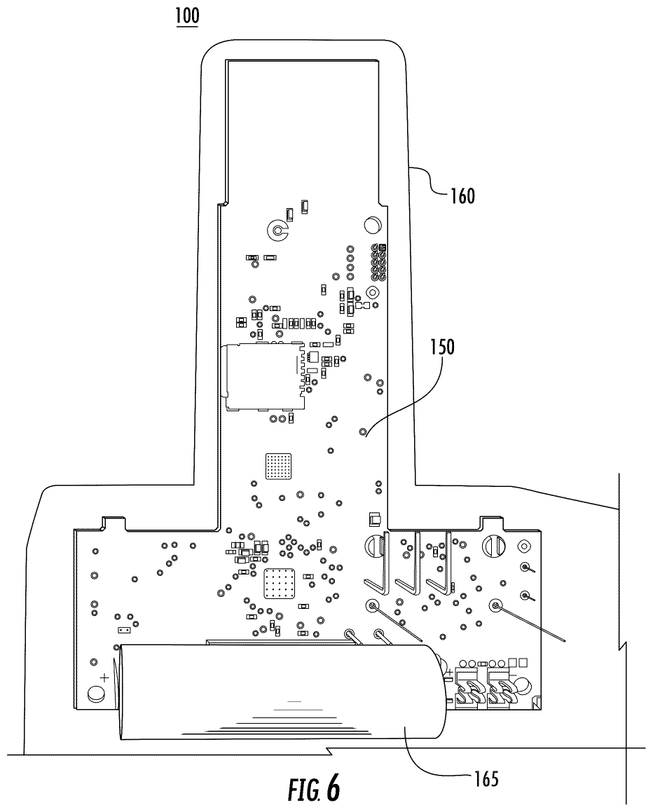

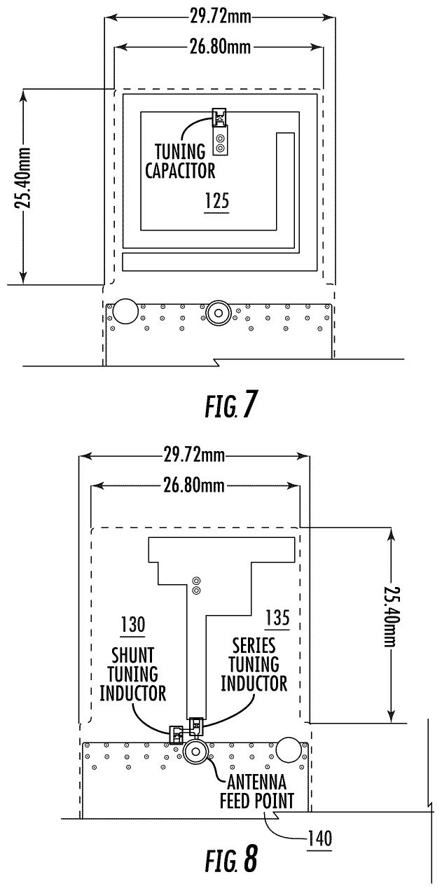

FIG. 6 shows a bottom side view of the antenna of FIGS. 1-5, along with the electrical and mechanical components 150 of a pit set module, for example, the Sensus SmartPoint® 520M Pit Set Module, in place. The antenna 100 top loading area is shown at the top of the figure. The hybrid layer capacitor (HLC) 165 is shown in place, while the battery of the system is not shown. FIG. 7 is a top side view of the antenna PCB 100 of FIGS. 1-6, showing the antenna tuning capacitor 125. FIG. 8 is a bottom side view of the antenna PCB 100 of FIGS. 1-7, showing the location of the antenna tuning inductors, shunt tuning inductor 130 and series tuning inductor 135, and antenna feed point 140. It will be understood that not all embodiments use both inductors 130 and 135. For example, in some embodiments, only the series inductor 135 is utilized.

In embodiments shown in FIGS. 1-8, the printed circuit board 145 has an inverted “T” shape. The elongated ground plane of the antenna 100 is enhanced by the shape of the circuit board of the pit set water meter module. The inverted “T” shape of the circuit board 145 enhances the antenna ground plane 110, improving the performance of the antenna 100 while maintaining a relatively short physical length. However, it will be understood that embodiments of the present inventive concept do not require a circuit board to be a “T” shape. Other shapes are possible. Furthermore, as shown in FIGS. 5 and 6, in some embodiments, the battery, touch coupler, and hybrid layer capacitor (HLC) of the water meter are also part of the ground system, and the antenna may be optimized for operation with the battery, touch coupler, and/or HLC installed in this location. In some embodiments, the battery may be a “D” cell-sized lithium battery, but may be any appropriate battery without departing from the scope of the present inventive concept. The battery and/or HLC may be installed at other locations on and/or near the circuit board and the placements shown are provided as examples only.

In operation the antenna shown in FIGS. 1-8, the first/lower frequency range of the antenna 100 is from about 700 MHz to 960 MHz. As discussed, the elongated ground plane 110 and spiral elements 115 which top load the monopole antenna 100 are used to obtain this frequency range. The addition of a series tuning inductor 135 and tuning capacitor 125 (shown in FIGS. 7 and 8) centers the band of operation of the lower frequency range. The series tuning capacitor 125 not only helps to center the lower frequency range of the antenna, but further allows for tuning out certain resonances that may impede the operation of the antenna 100. As shown in FIG. 7, the tuning capacitor may also couple the spiral top loading of the antenna to the patch top loading of the antenna in such a way to enhance the coupling between the two. Additionally, the feed for the lower frequency range is shared with that for the upper frequency range, which allows the antenna system 100 to have one input point, for example, a 50 Ohm input point, allowing for ease of signal injection and reception.

Similarly, the second/upper frequency range of the antenna operation, for example, from about 1700-2200 MHZ, utilizes the elongated ground plane, feed line for the antenna, and patches attached to the feed line of the antenna. A series matching inductor 135 may center the frequency range of the upper frequency operation of the antenna. The series matching inductor 135 may allow a length of the antenna to be decreased as compared to an antenna constructed without the series inductor. Such a size/length reduction of the antenna 100 may provide more space for other circuitry in the water meter module. As noted above, the feed for the upper frequency range may be shared with that of the lower frequency range, allowing the antenna system to have one (e.g. 50 Ohm) input point, allowing for ease of signal injection and reception.

Other compact antenna designs have previously been contemplated, such as that disclosed in a conference paper by Bao et al. (Bao, X. L. & M. J. (2010) Ammann, Compact Spiral Loaded Printed Monopole Antenna,” European Conference on Antennas and Propagation-EuCAP, Barcelona, Spain, Cl 2P2-4, Dec. 4, 2010, doi: 10.21427/D75S3T). Unlike the antennas discussed in Bao, antennas in accordance with embodiments discussed herein have two distinct bands of operation, for example, 700-960 MHz and 1700-2200 MHz. Additionally, the antennas discussed herein have a wider bandwidth in the bands below 1000 MHz than that described in Bao, while also having an additional operating range of 1700-2200 MHz that is not contemplated in Bao.

Furthermore, the antenna 100 in accordance with embodiments discussed herein radiate signals in both the upper and lower LTE bands from the spiral loading/radiating elements, its feeding structure, and ground plane, and the antenna of the present inventive concept has its spiral and patch elements enclosed in an area smaller than that discussed in Bao.

Additionally, the antenna 100, according to some embodiments of the present inventive concept, uses lumped tuning elements, for example, inductor(s) and capacitor(s), to enhance antenna operation and matching across the operational bands of the antenna. The antenna in accordance with embodiments of the present inventive concept may also use the same components utilized for matching to “push” destructive resonances caused by the antenna physical dimensions out of the operating bands of the antenna.

As discussed above, in some embodiments, the antenna 100 may be constructed by depositing copper traces on FR4 fiberglass printed circuit board (PCB) substrate. FR4 material may be chosen for ease of manufacture and cost. However, it is to be understood that other material(s) for the PCB substrate may be chosen, and the material on which the antenna copper traces are deposited could be one of several materials including (but not limited to) plastic, Teflon, ceramic, or glass. Any substrate commonly used for antennas which provides a low loss could be used for the antenna. Additionally, the copper traces utilized were also selected for ease of manufacture and cost, but any material with a high conductivity could be used for the traces including (but not limited to) gold, silver, aluminum, or brass.

In some embodiments, the size of the antenna 100 may be optimized for FR4 material and copper traces. Using other substrate or trace material may influence the overall antenna size. In further embodiments, other materials could be utilized to allow the antenna to be smaller and/or more compact than illustrated in FIGS. 1-8.

In some embodiments of the present inventive concept, the antenna radiating elements are placed on the top and the bottom sides of the PCB. In some embodiments, the PCB may contain more than two layers. However, in other embodiments, the PCB may contain two or fewer layers. In further embodiments, the antenna may utilize a four-layer PCB. In these embodiments, the ground plane for the antenna resides on all four layers of the PCB, electrically tied together by via holes. The non-ground plane antenna elements in a water meter module reside on the top and bottom layers of a four-layer PCB, with no copper traces in the layers between them. It is to be noted that the PCB layer count could be greater than four layers, if needed.

In some embodiments, the ground plane for the antenna may reside on internal layers of the PCB, the top layer of the PCB, the bottom layer of the PCB, or a combination of layers of the PCB. Regardless of the configuration, proper ground plane interconnection with plated via holes is generally important.

The antenna in accordance with some embodiments of the present inventive concept has a main ground plane on an internal layer of the PCB, with a non-homogeneous ground layer on the top and bottom of the PCB. The antenna may operate with a solid ground plane layer on the top, bottom, and internal layer(s) of the PCB and, thus, it is to be understood that the antenna ground plane may occupy any or all layers of the PCB.

The antenna in accordance some embodiments of the present inventive concept may be constructed on an FR4 PCB substrate with overall thickness of 0.62 inches (1.575 mm), and have the various dimensions shown in FIGS. 1-8. The PCB thickness may be selected due to cost, mechanical stability, and manufacturing needs. However, it is to be understood that the PCB thickness may be thinner or thicker, if desired, with the appropriate antenna design changes needed to capitalize on different thicknesses.

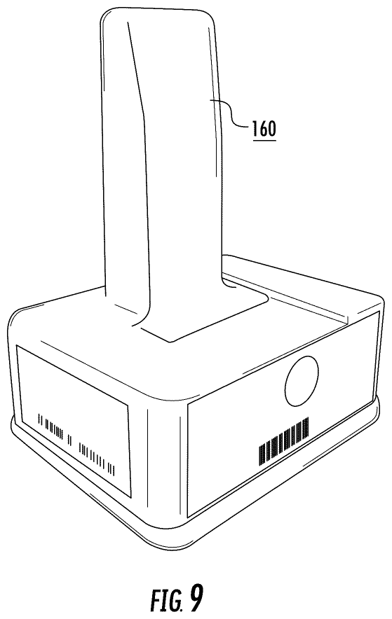

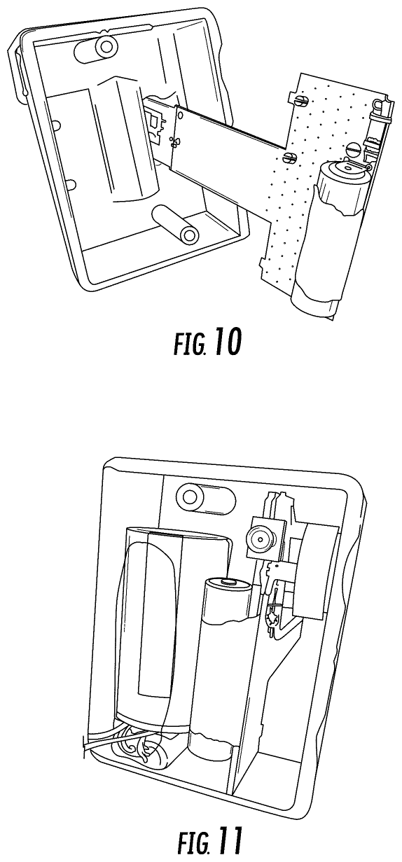

Typically, a water meter module such as the Sensus SmartPoint® 520M Pit Set Module is enclosed/encased in a housing 160 made of, for example, an HDPE plastic material, which generally prevents water infiltration into the module over its intended life span, for example, about 20 years. The HDPE plastic material's dielectric constant (e.g., approximately 2.1) can affect the antenna's functionality, and the antenna in accordance with the present inventive concept is designed to offset any influence caused by the HDPE enclosure/housing material dielectric. An example housing 160 is illustrated as an HDPE plastic enclosure in FIG. 9 with the water meter module electronics enclosed therein in FIG. 10.

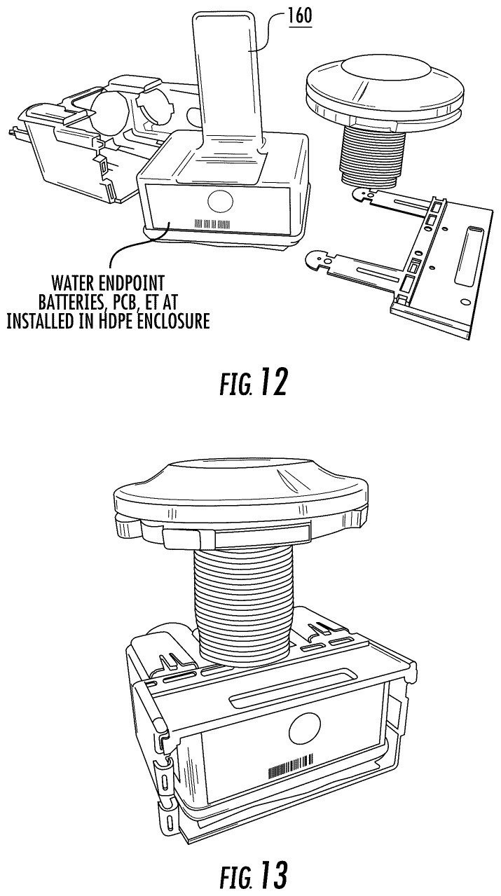

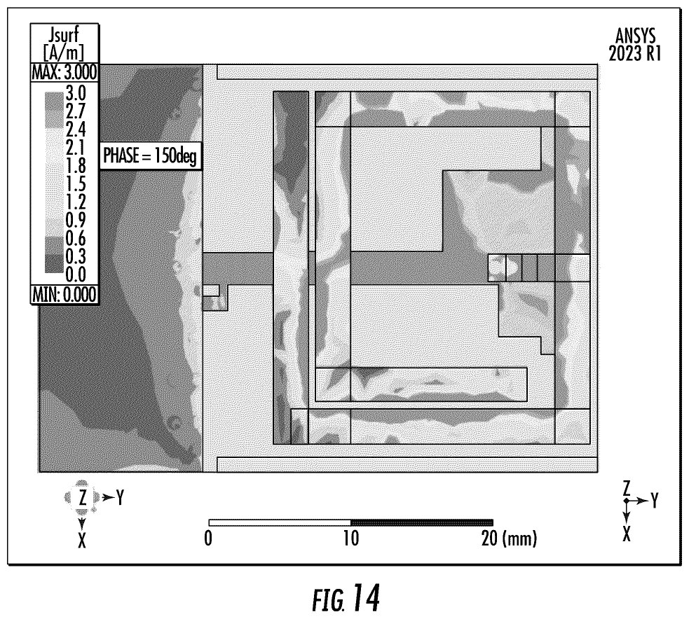

FIG. 11 illustrates a water meter unit in accordance with the present inventive concept, with a battery, touch coupler, and HLC installed in an HDPE case/enclosure. The bottom cover of the HDPE case/enclosure is omitted for clarity. FIG. 12 shows a disassembled HDPE enclosure of the water meter module showing plastic mounting hardware.

In some embodiments, the water meter module, housed/enclosed in its HDPE plastic material, may be installed as-is. However, in other embodiments, the water meter module and HDPE plastic material enclosure may be inserted into another plastic housing. FIG. 13 illustrates a fully assembled water meter module with HDPE case/enclosure and additional plastic housing for “water pit” installation. This allows for ease of installation of the water meter module in ground water meter enclosures (i.e., “water pits”). The plastic housing may affect the antenna further, as it has its own dielectric constant, for example, approximately 3.1. The antenna is designed to offset any influence caused by this additional enclosure being utilized.

As A discussed above, the water meter module in accordance with the present inventive concept is designed and tuned to allow for installation within various enclosures, as shown in FIGS. 9-13. If necessary, the tuning components on the antenna PCB may be adjusted for the best performance. These tuning components (e.g., a lumped capacitor and lumped inductor) allow for easy adaptability of the antenna tuning.

Referring now to FIGS. 14-25, simulated operation of the antenna shown and described with respect to FIGS. 1-8 at various frequencies is illustrated. The antenna radiator surface currents produce electromagnetic radiation, and FIGS. 14-25 show the antenna radiator surface currents at several frequencies over the antenna operating range. It will be understood that FIGS. 14-25 are provided in grey scale and the various shades of grey depict values as shown in the legend provided with each of these figures.

The surface current comprises that which emanates from the copper traces at the top of the PCB and the ground plane which comprises the bottom of the PCB. For brevity and clarity, only the top portion of the antenna structure is shown in the figures. Additionally, the simulations shown in FIGS. 14-25 illustrate antenna performance inclusive of an HDPE enclosure and additional plastic housing, but the structure of the HDPE enclosure and additional plastic housing have been omitted for clarity.

In FIGS. 14-25, it is to be understood that the surface current shown in simulation is highest as shown in the legends discussed above and corresponding radiation amount (in Amps/meter) provided in each figure.

As can be seen in FIGS. 14-25, in accordance with the present inventive concept, the most efficient surface current area on the antenna varies for each frequency range across the lower end of the LTE band (e.g., 700-960 MHZ) and the upper end of the LTE band (e.g., 1700-2200 MHz). In other words, the antenna radiates from distinctly different areas in the low band operating frequencies versus the high band operating frequencies.

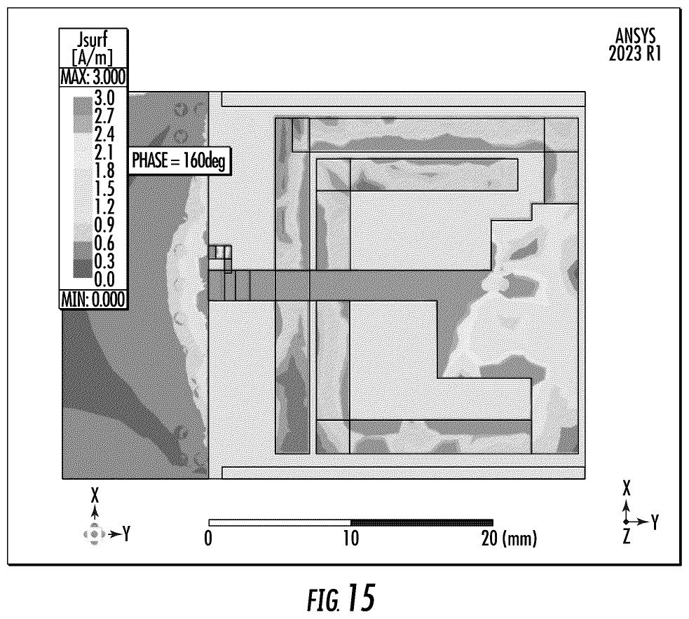

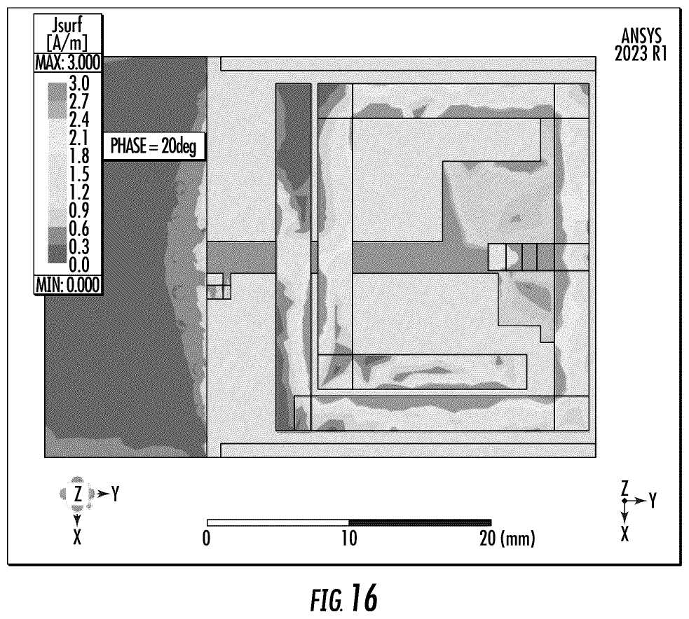

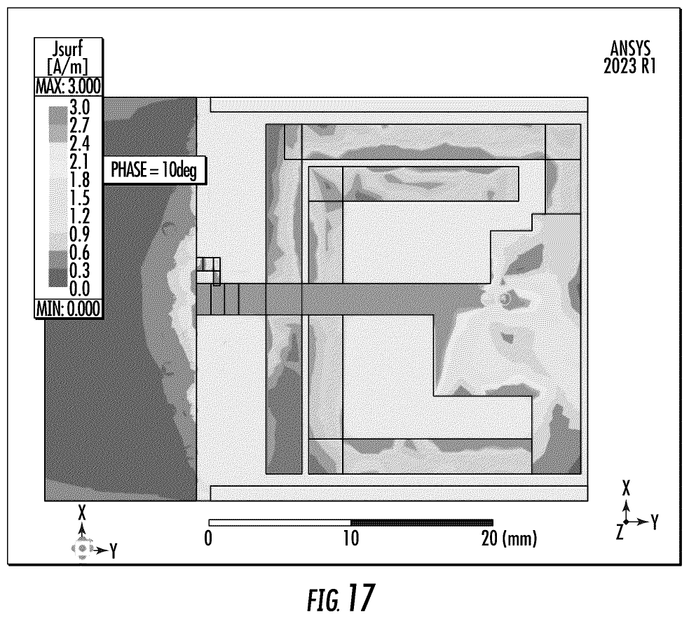

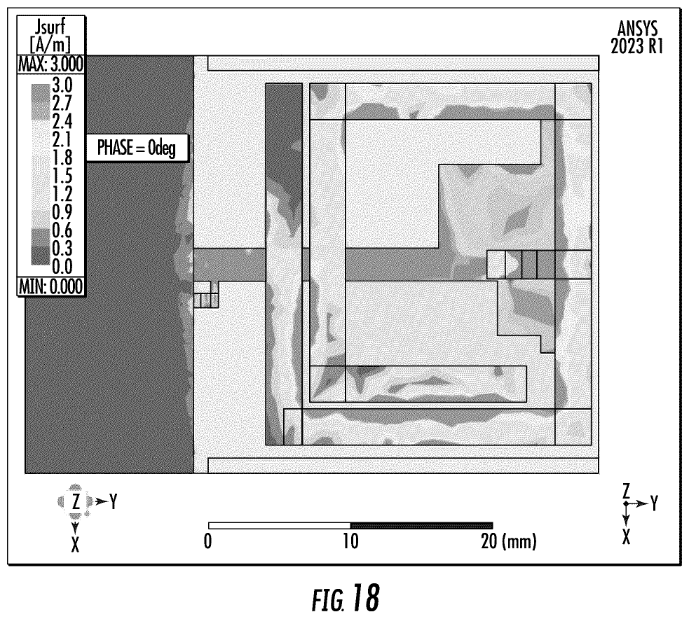

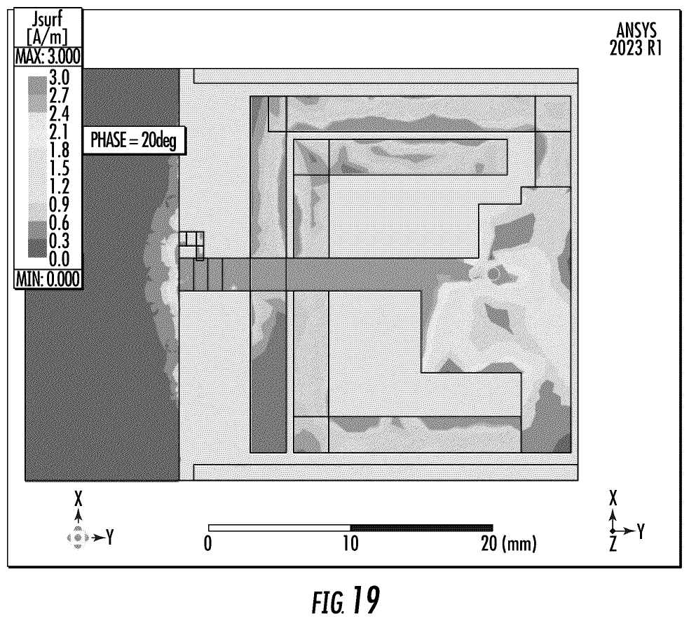

For example, in the lower end of the LTE band, FIGS. 14 and 15 show surface current in accordance with the present inventive concept at 700 MHz, with FIG. 14 as viewed from top of PCB (looking through the PCB), and FIG. 15 as viewed from the bottom of the PCB. FIGS. 16 and 17 show surface current at 850 MHz, with FIG. 16 as viewed from top of PCB, and FIG. 17 as viewed from the bottom of the PCB. FIGS. 18 and 19 illustrate surface current at 960 MHz, with FIG. 18 as viewed from the top of the PCB, and FIG. 19 as viewed from the bottom of the PCB.

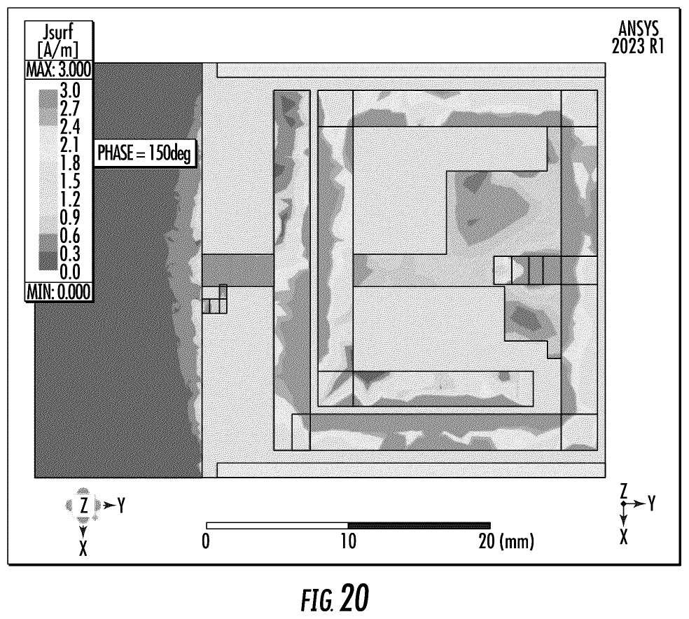

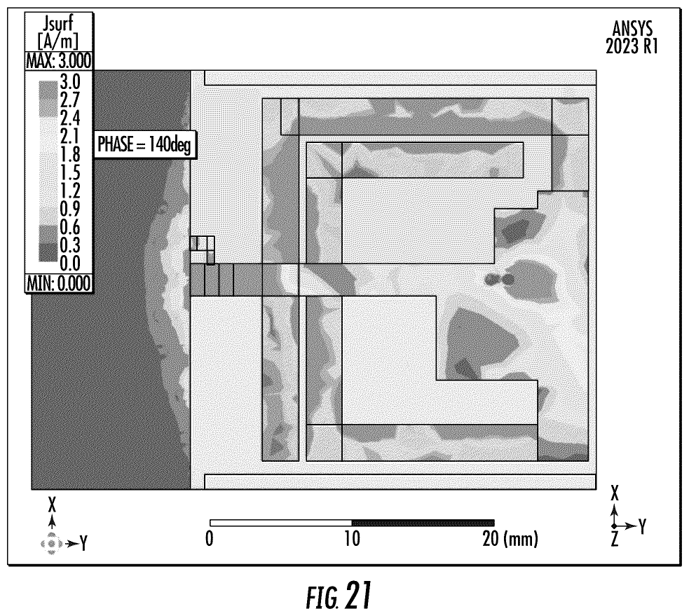

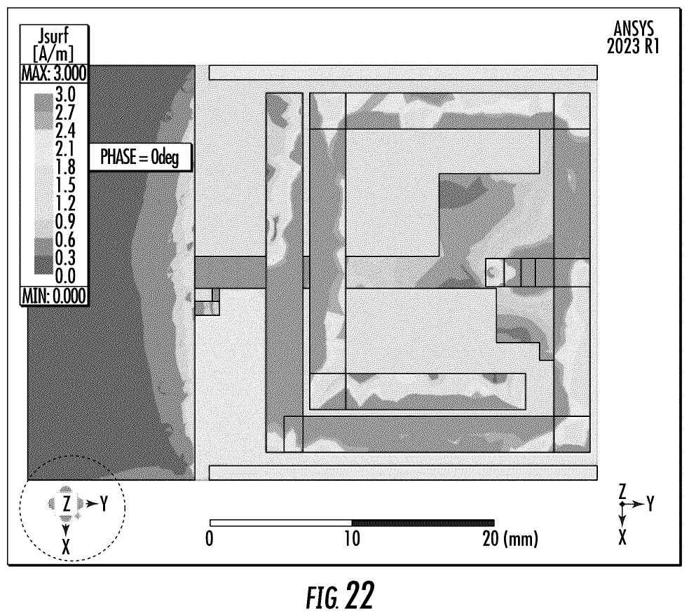

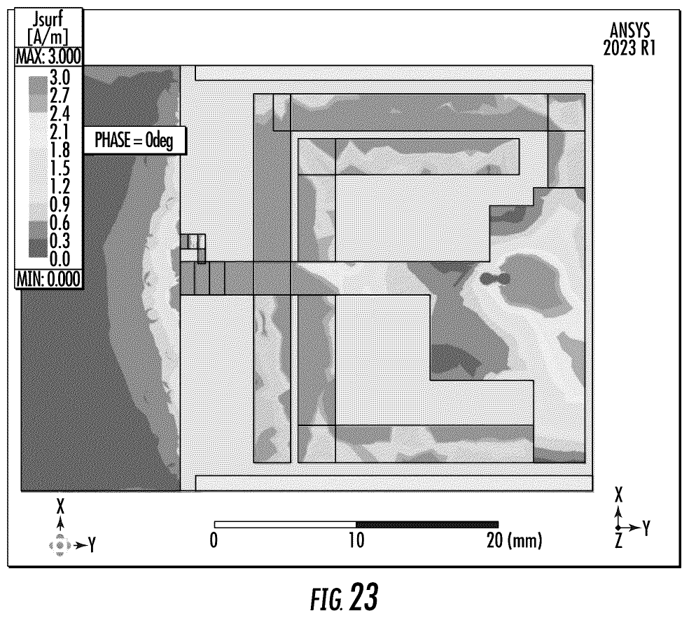

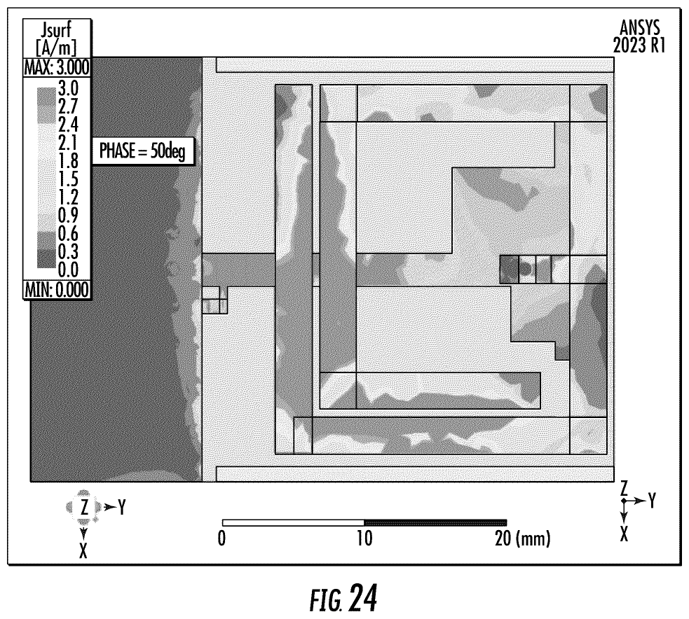

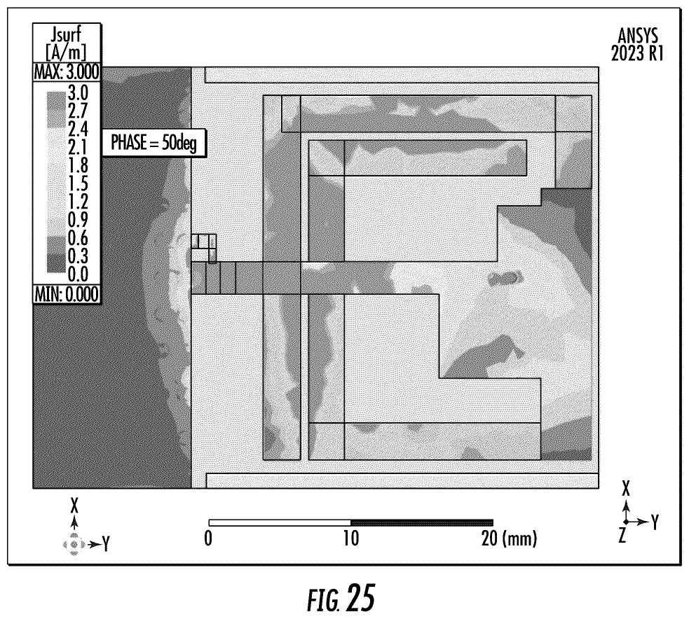

On the other hand, at the upper end of the LTE band, FIGS. 20 and 21 show surface current at 1700 MHZ, with FIG. 20 as viewed from the top of the PCB, and FIG. 21 as viewed from the bottom of the PCB. FIGS. 22 and 23 show surface current at 1900 MHZ, with FIG. 22 as viewed from the top of the PCB and FIG. 23 as viewed from the bottom of the PCB. Finally, FIGS. 24 and 25 show surface current at 2200 MHz, with FIG. 24 as viewed from the top of the PCB, and FIG. 25 as viewed from the bottom of the PCB.

As is evidenced by the respective lower end LTE band views (FIGS. 14-19) and the upper end LTE band views (FIGS. 20-25), the antenna of the present inventive concept is designed to radiate from distinct areas, dependent upon the operating frequency.

The surface current simulations and performance results shown in FIGS. 14-25 were obtained taking into account the specific placement of the copper traces on the top and bottom of the PCB, the gap between the traces, the length of the traces, the thickness of the PCB, the dielectric constant of the PCB, the inclusion of the battery and HLC masses, the inclusion of the dielectric constants of each plastic/HDPE portion of the enclosure, and tuning through simulation. Dependent upon at least these variables, the portion(s) of the antenna obtaining the highest level of radiation at any given frequency changes, as evidenced by the simulations shown in FIGS. 14-25.

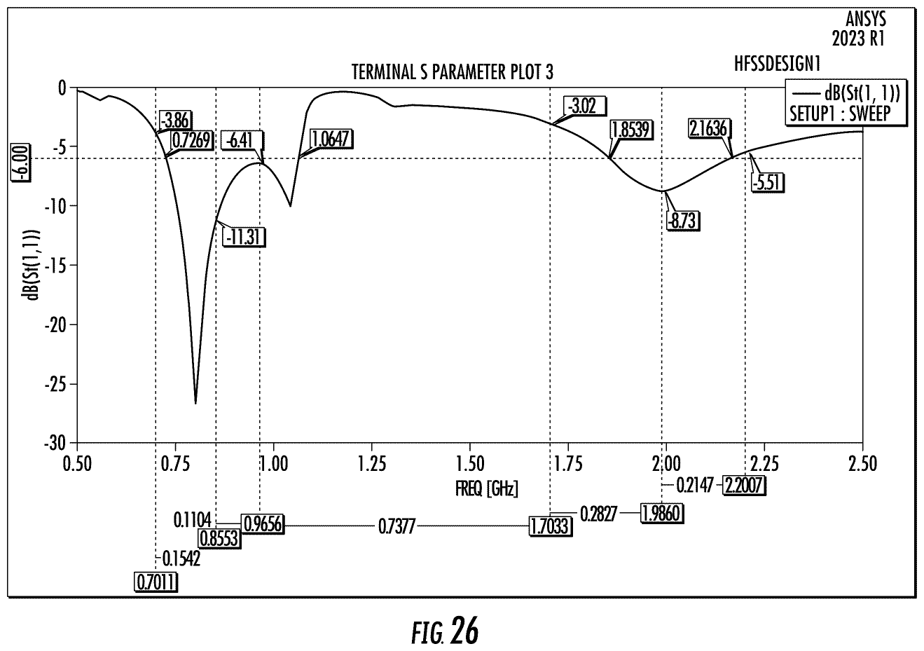

Referring now to FIGS. 26-33, various representations of simulated antenna performance are shown. In particular, FIG. 26 is a plot showing antenna return loss (in dB) versus frequency (in GHz), with 6.0 dB of return loss results in better than 3:1 voltage standing wave ratio (VSWR).

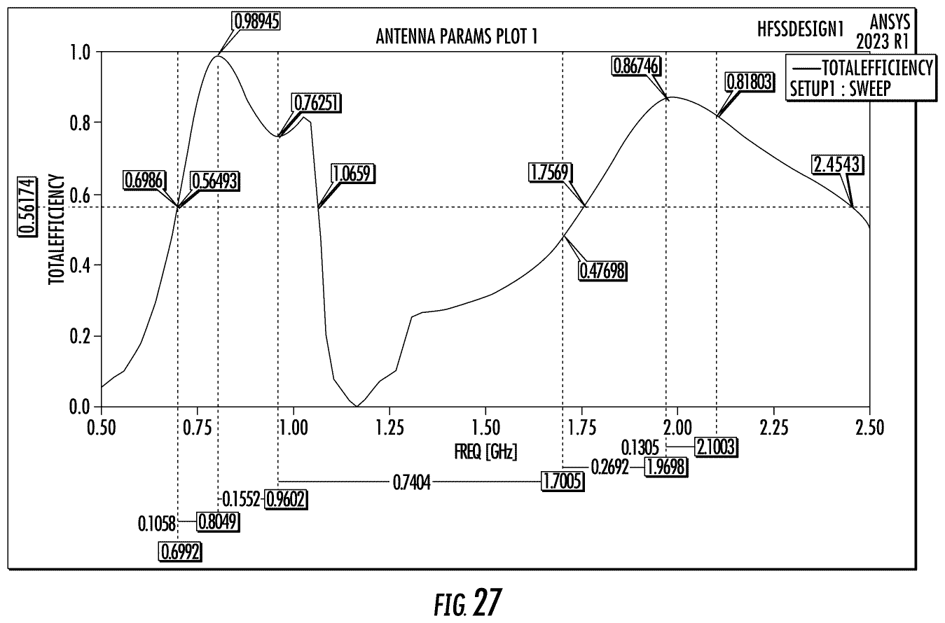

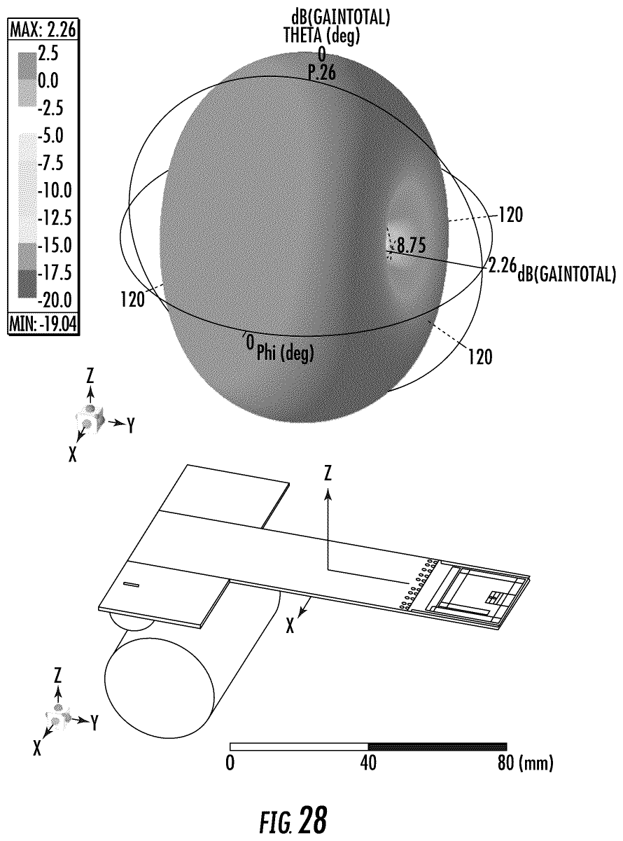

FIG. 27 is a plot showing simulated antenna efficiency versus frequency (in GHz). As shown in FIG. 27, the antenna of the present inventive concept is better than-60% efficient over a broad range of LTE frequencies.

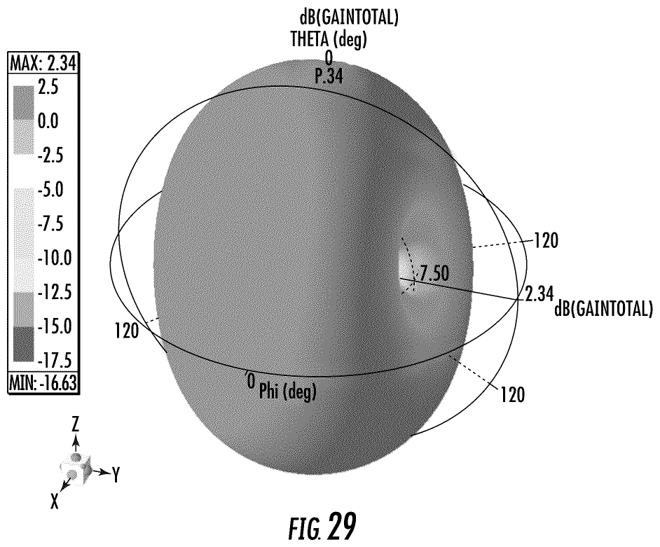

FIGS. 28-33 illustrate three-dimensional (3D) antenna radiation at various frequencies in both the lower and upper LTE bands, with the “Y” axis direction pointing to top portion of the PCB.

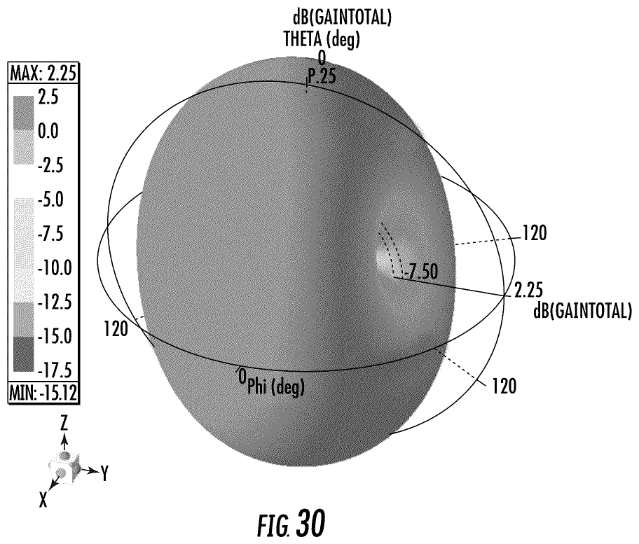

On the lower end of the LTE band, FIG. 28 shows three-dimensional (3D) antenna radiation at 700 MHz. FIG. 29 shows 3D antenna radiation at 850 MHz. FIG. 30 shows antenna radiation at 960 MHz.

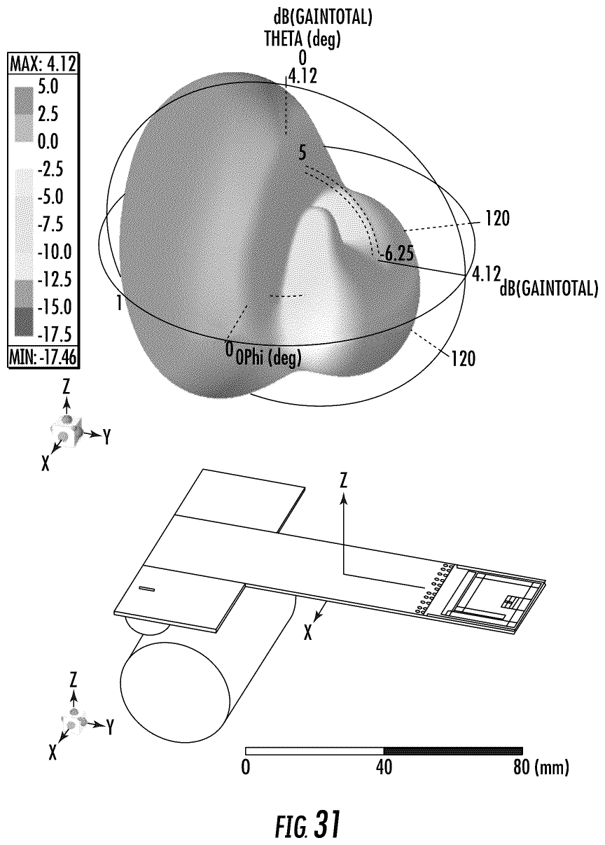

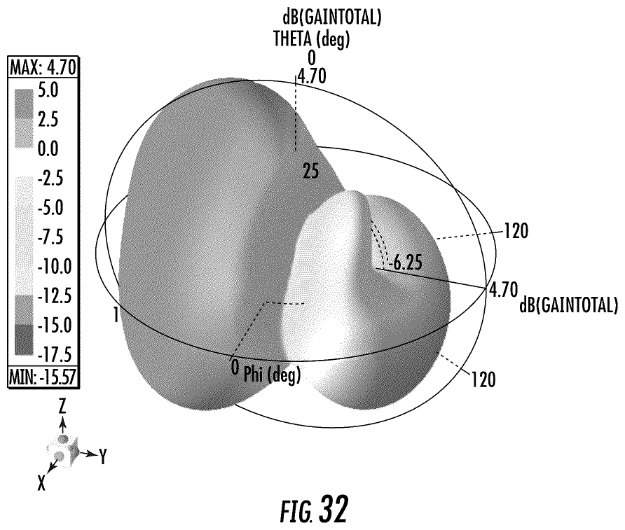

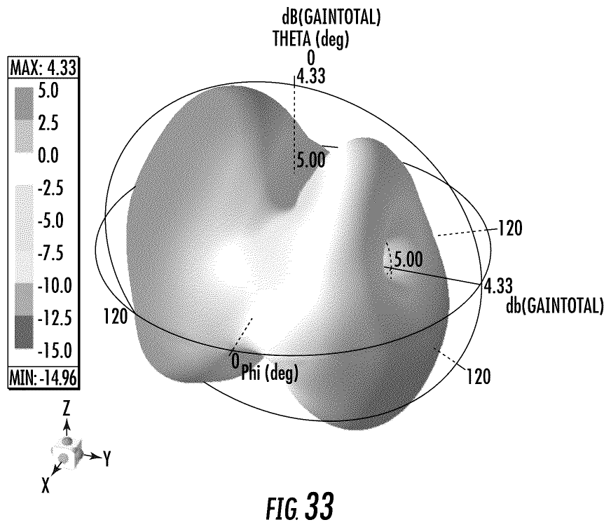

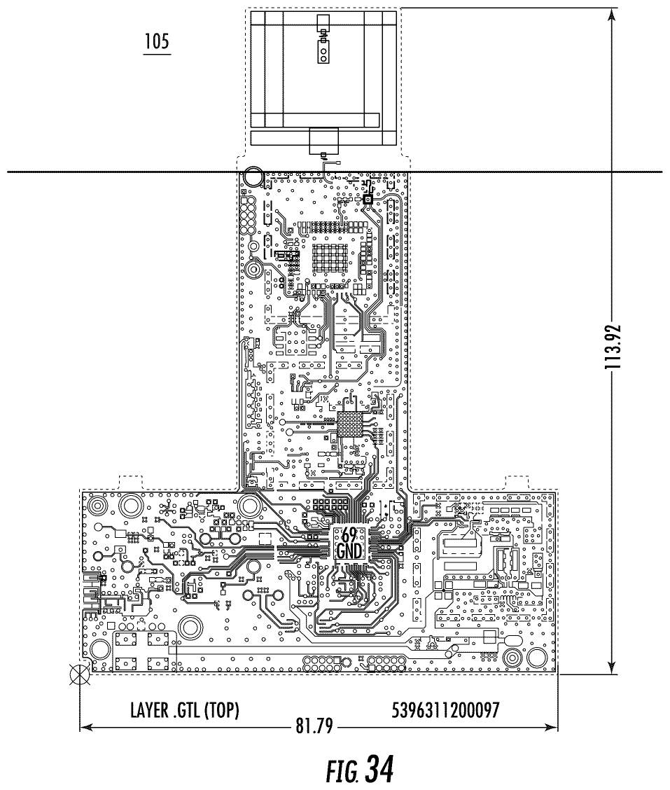

On the upper end of the LTE band, FIG. 31 shows 3D antenna radiation at 1700 MHz. FIG. 32 shows 3D antenna radiation at 1900 MHz. FIG. 33 shows 3D antenna radiation at 2200 MHz. In the upper LTE band, the 3D antenna radiation pattern may be affected by the battery of the system, which influences radiation out of the top of the antenna. Similar to the legends discussed above with respect to FIGS. 14-25, FIGS. 28-33 are provided in grey scale and the various shades of grey depict values as shown in the legend provided with each of these figures. Referring now to FIGS. 34-37, an antenna 105 in accordance with further embodiments of the present inventive concept will be discussed. It is to be understood that the antenna shown in FIGS. 34-37 has the same or substantially similar dimensions as that shown and described in relation to the antenna of FIGS. 1-8, but there are notable differences in the feed point location on the bottom side of the antenna PCB between the two embodiments.

In particular, FIG. 34 shows a top view of an antenna in accordance with further embodiments of the present inventive concept, the antenna may be constructed on an FR4 printed circuit board as discussed above with respect to embodiments illustrated in FIGS. 1-8. As noted above, the dimensions of the antenna of FIG. 34 may be the same as or substantially similar to those of the antenna shown and described with respect to FIGS. 1-8, however, embodiments are not limited thereto.

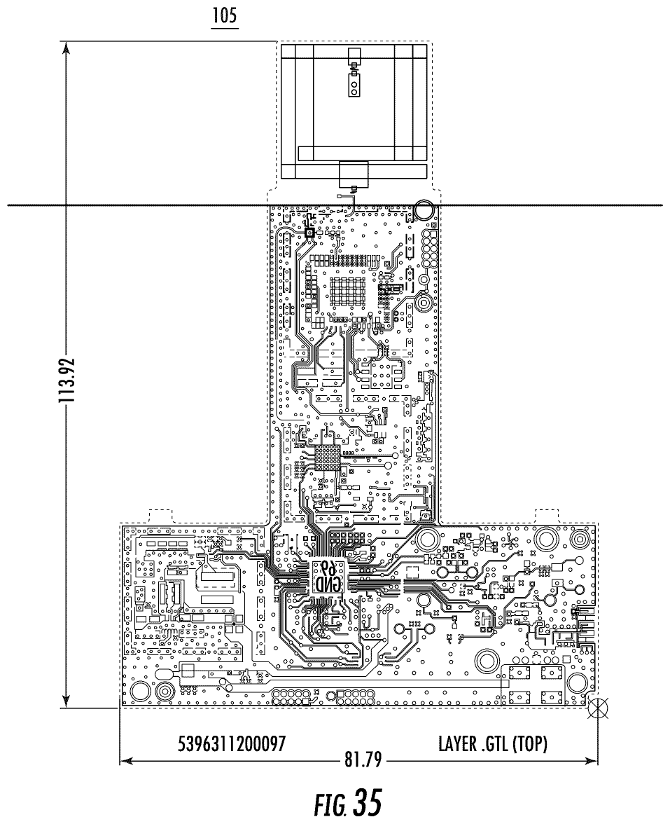

FIG. 35 shows a bottom view of the antenna of FIG. 35. FIG. 36 shows the antenna of FIGS. 34 and 35, with the view looking through the PCB from the top side of the PCB, illustrating the spiral portion of the antenna. Additionally, FIG. 36 shows the location of a tuning capacitor of the antenna 105 in accordance with further embodiments of the present inventive concept.

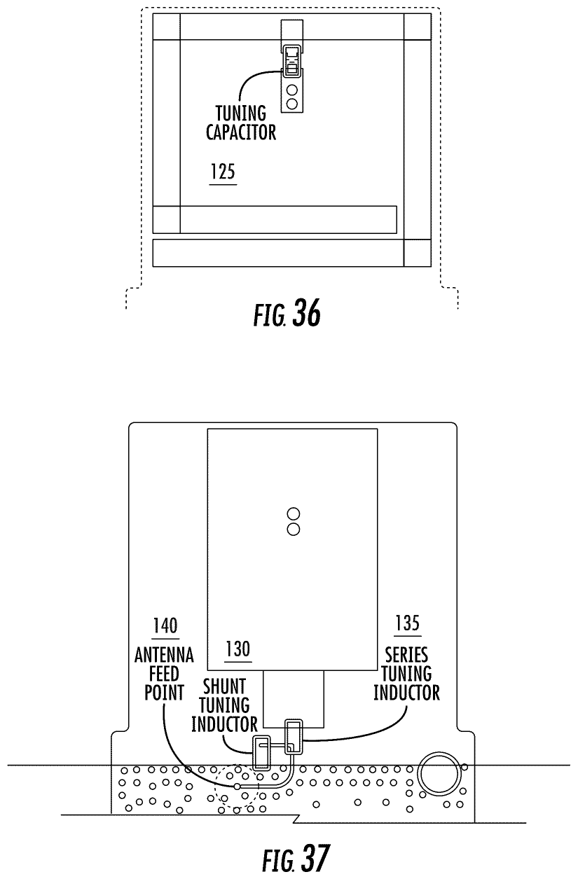

FIG. 37 shows the antenna of FIGS. 34-36 d, with the view looking through the PCB from the bottom side of the PCB and illustrating the stepped patch portion of the antenna of the present embodiment. It is to be noted that the location of the antenna feed point 140 in the antenna 105 of FIG. 37 is different than that of the antenna shown in FIG. 8. Similar to the feed point shown in FIG. 8, in some embodiments, the feed point shown in FIG. 37 is at 50 Ohms. However, unlike the feed point of FIG. 8, the feed point of FIG. 37 is coupled to a series tuning inductor 135 by, for example, a microstrip line.

FIG. 37 also shows the location of the antenna tuning inductors, shunt tuning inductor 130 and series tuning inductor 135. In some embodiments, the antenna 105 may include at least one shunt tuning inductor and at least one series tuning inductor. However, in other embodiments, only the at least one series tuning inductor may be used.

It will be understood that the antenna 105 of FIGS. 34-37 may be sized and configured to be disposed within an enclosure that is the same as or substantially similar to that shown and described above with respect to FIGS. 9-11, and may also be designed and optimized for use with an additional housing such as that shown in FIGS. 12 and 13.

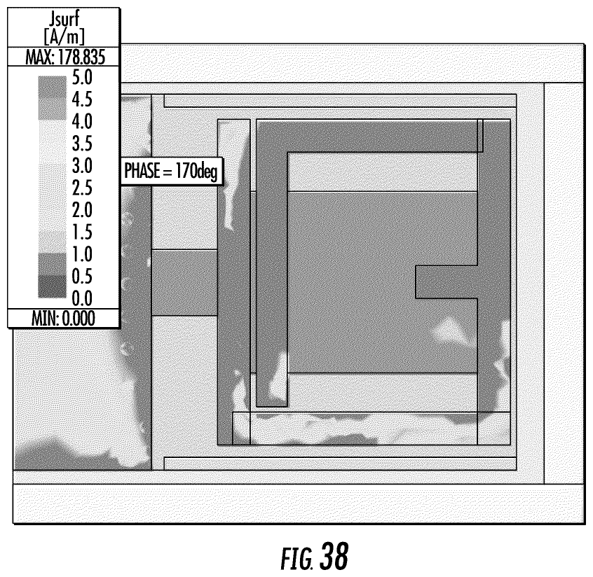

Referring now to FIGS. 38-49, simulated operation of the antenna shown and described with respect to FIGS. 34-37 at various frequencies is illustrated. The surface current comprises that which emanates from the copper traces at the top of the PCB and the ground plane which comprises the bottom of the PCB. It is to be understood that the antenna ground plane interaction and performance are key to the overall operation of the antenna, as will be discussed further herein. FIGS. 38-49 are provided in grey scale and the various shades of grey depict values as shown in the legend provided with each of these figures

For brevity and clarity, only the top portion of the antenna structure is shown in the figures. Additionally, the simulations shown in FIGS. 38-49 illustrate antenna performance inclusive of an HDPE enclosure and additional plastic housing, but the structure of the HDPE enclosure and additional plastic housing have been omitted for clarity.

In FIGS. 38-49, it is to be understood that the surface current shown in simulation is highest as shown in the corresponding legends and corresponding radiation amount (in Amps/meter) provided in each figure.

As can be seen in FIGS. 38-49, in accordance with embodiments of the present inventive concept, the most efficient surface current area on the antenna varies for each frequency range across the lower end of the LTE band (e.g., 700-960 MHZ) and the upper end of the LTE band (e.g., 1700-2200 MHz). In other words, the antenna radiates from distinctly different areas in the low band operating frequencies versus the high band operating frequencies.

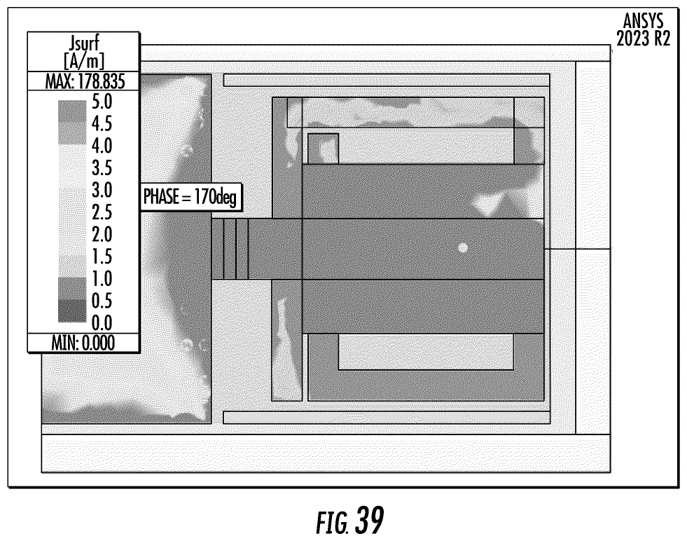

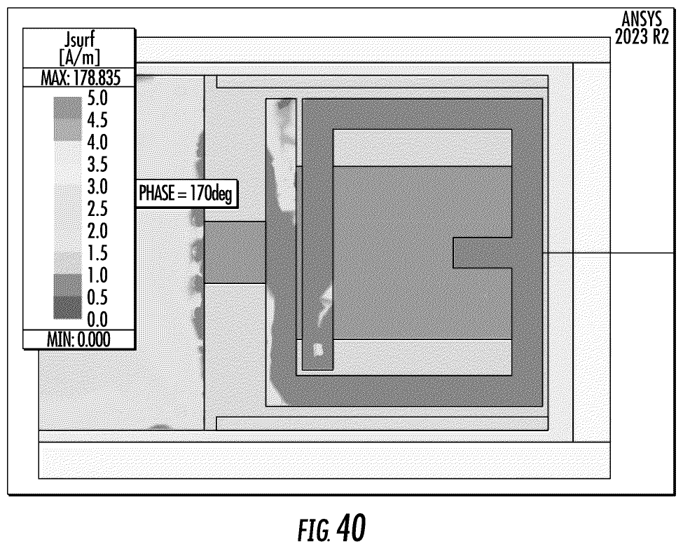

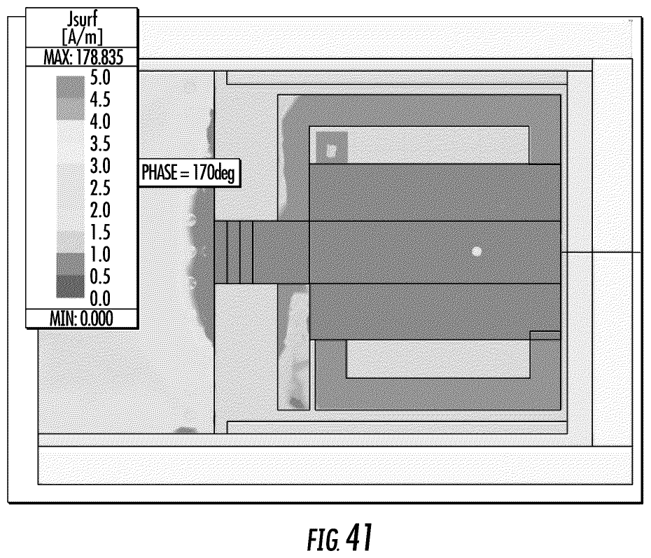

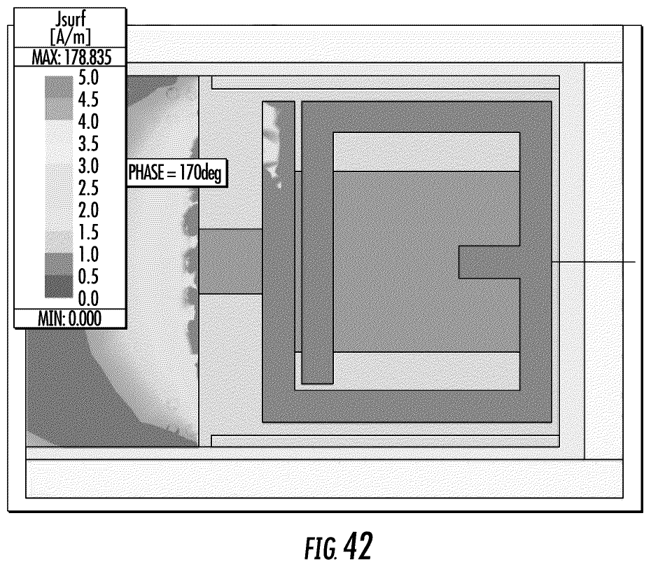

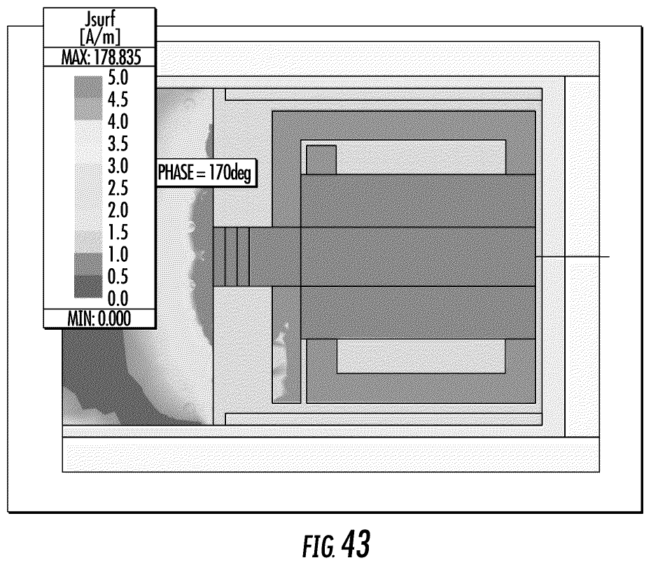

For example, in the lower end of the LTE band, FIGS. 38 and 39 show surface current in accordance with an embodiment of the present inventive concept at 700 MHz, with FIG. 38 as viewed from top of PCB (looking through the PCB), and FIG. 39 as viewed from the bottom of the PCB. FIGS. 40 and 41 show surface current at 850 MHZ, with FIG. 40 as viewed from top of PCB, and FIG. 41 as viewed from the bottom of the PCB. FIGS. 42 and 43 illustrate surface current at 960 MHz, with FIG. 42 as viewed from the top of the PCB, and FIG. 43 as viewed from the bottom of the PCB.

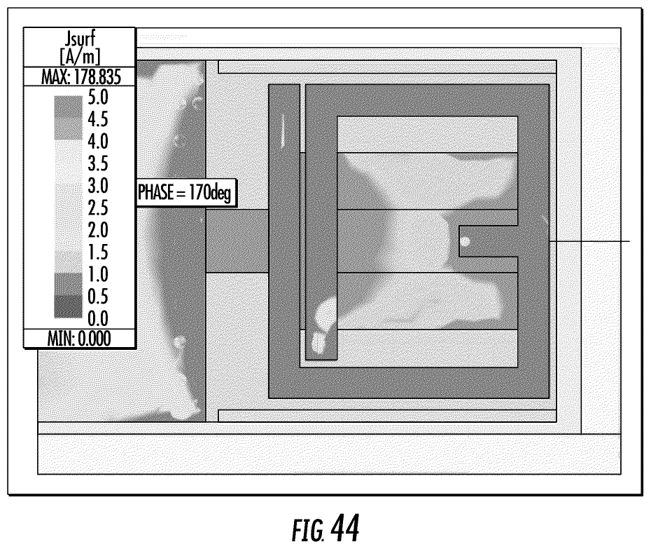

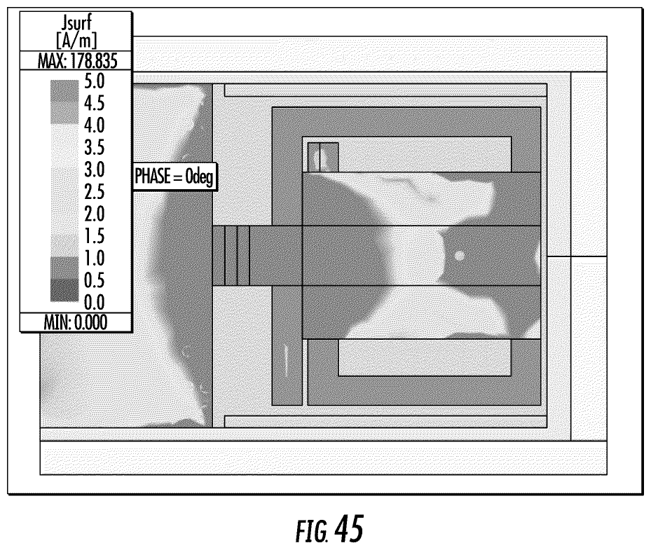

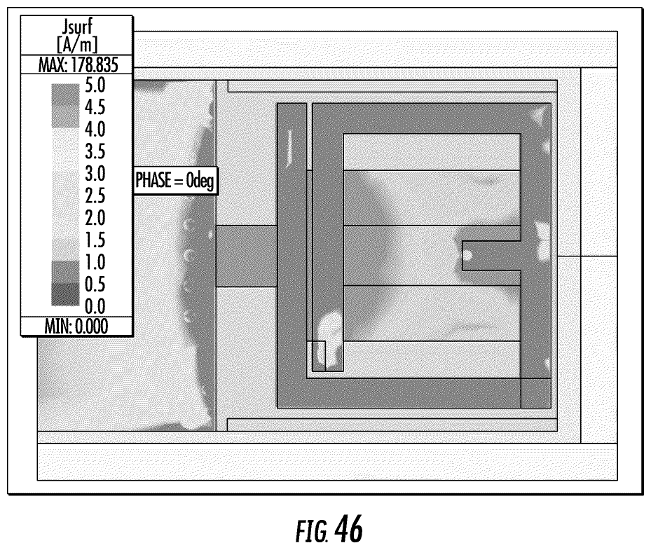

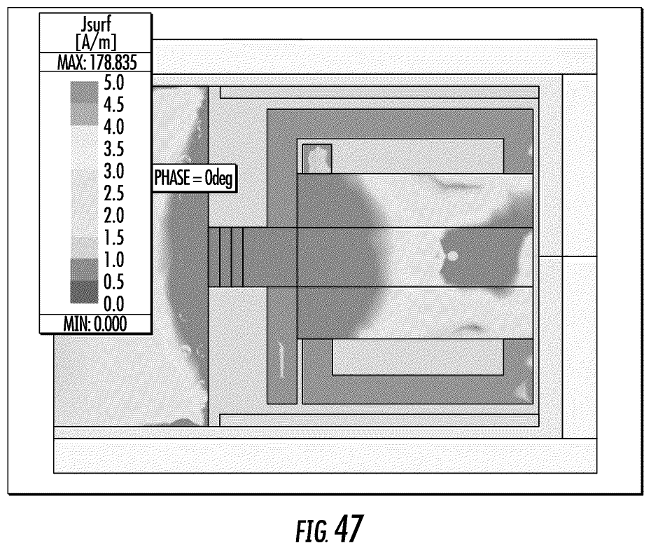

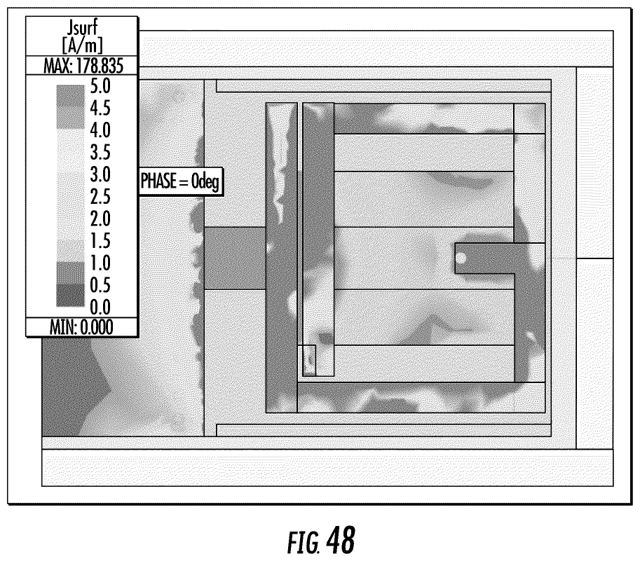

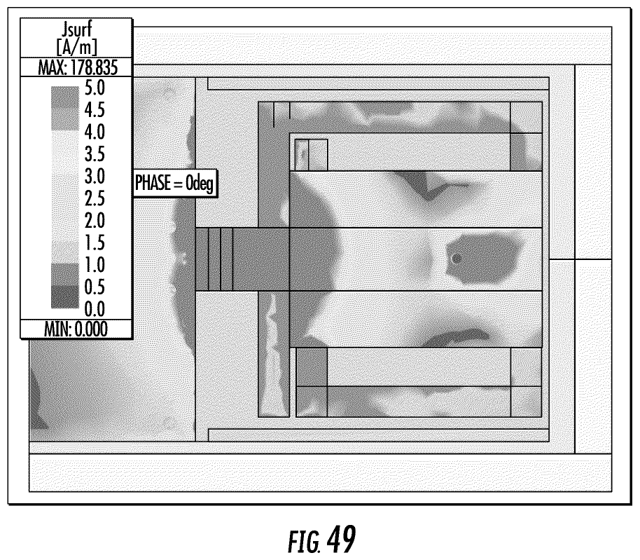

Conversely, at the upper end of the LTE band, FIGS. 44 and 45 show surface current at 1700 MHZ, with FIG. 44 as viewed from the top of the PCB, and FIG. 45 as viewed from the bottom of the PCB. FIGS. 46 and 47 show surface current at 1900 MHZ, with FIG. 46 as viewed from the top of the PCB and FIG. 47 as viewed from the bottom of the PCB. Finally, FIGS. 48 and 49 show surface current at 2200 MHz, with FIG. 48 as viewed from the top of the PCB, and FIG. 49 as viewed from the bottom of the PCB.

Again, as is evidenced by the respective lower end LTE band views (FIGS. 38-43) and the upper end LTE band views (FIGS. 44-49), the antenna 105 of the present inventive concept is designed to radiate from distinct areas, dependent upon the operating frequency.

The surface current simulations and performance results shown in FIGS. 38-49 were obtained taking into account the specific placement of the copper traces on the top and bottom of the PCB, the gap between the traces, the length of the traces, the thickness of the PCB, the dielectric constant of the PCB, the inclusion of the battery and HLC masses, the inclusion of the dielectric constants of each plastic/HDPE portion of the enclosure, and tuning through simulation. Dependent upon at least these variables, the portion(s) of the antenna obtaining the highest level of radiation at any given frequency changes, as evidenced by the simulations shown in FIGS. 38-49.

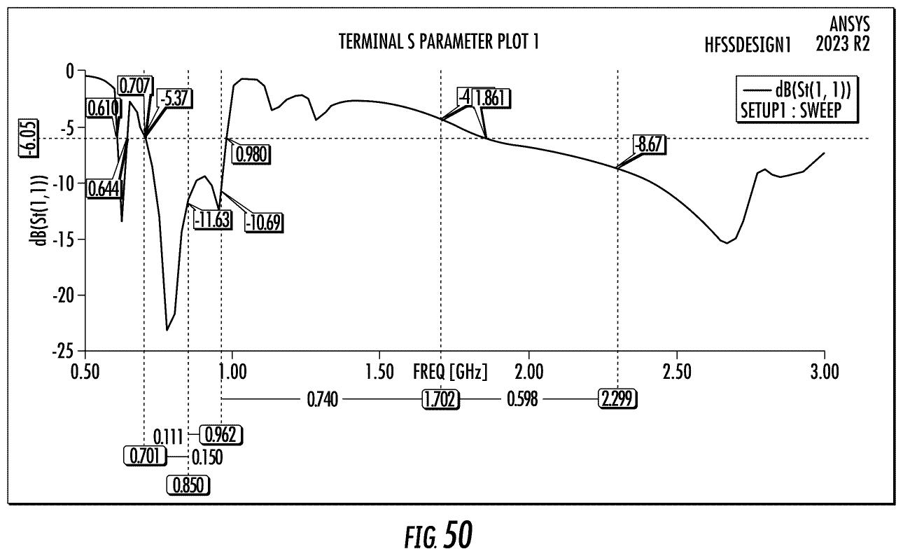

Referring now to FIGS. 50-57, various representations of simulated antenna performance in accordance with the antenna embodiment of FIGS. 34-37 are shown. In particular, FIG. 50 is a plot showing antenna return loss (in dB) versus frequency (in GHz), with 6.0 dB of return loss results in better than 3:1 voltage standing wave ratio (VSWR).

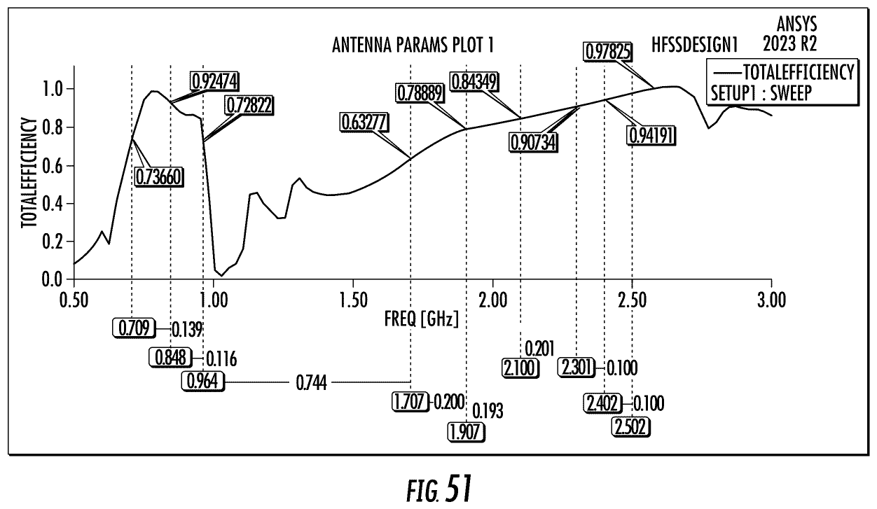

FIG. 51 is a plot showing simulated antenna efficiency versus frequency (in GHz). As shown in FIG. 51, the antenna of the present embodiment of the inventive concept is better than-60% efficient over a broad range of LTE frequencies.

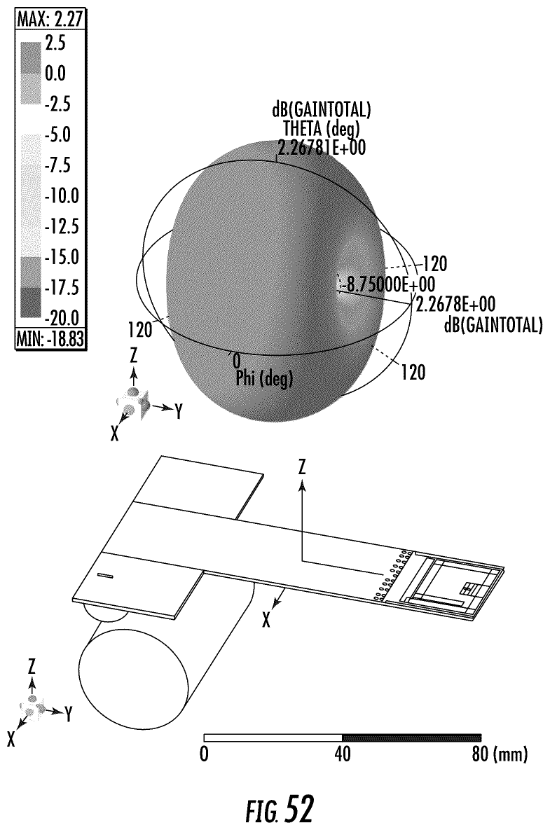

FIGS. 52-57 illustrated three-dimensional (3D) antenna radiation at various frequencies in both the lower and upper LTE bands are shown, with the “Y” axis direction pointing to top portion of the PCB.

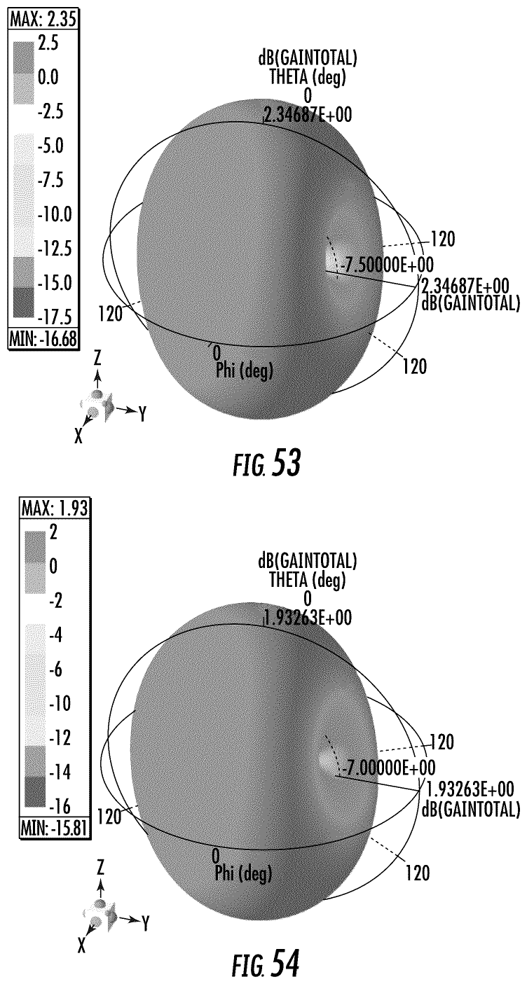

On the lower end of the LTE band, FIG. 52 shows 3D antenna radiation at 700 MHz. FIG. 53 shows 3D antenna radiation at 850 MHz. FIG. 54 shows 3D antenna radiation at 960 MHz.

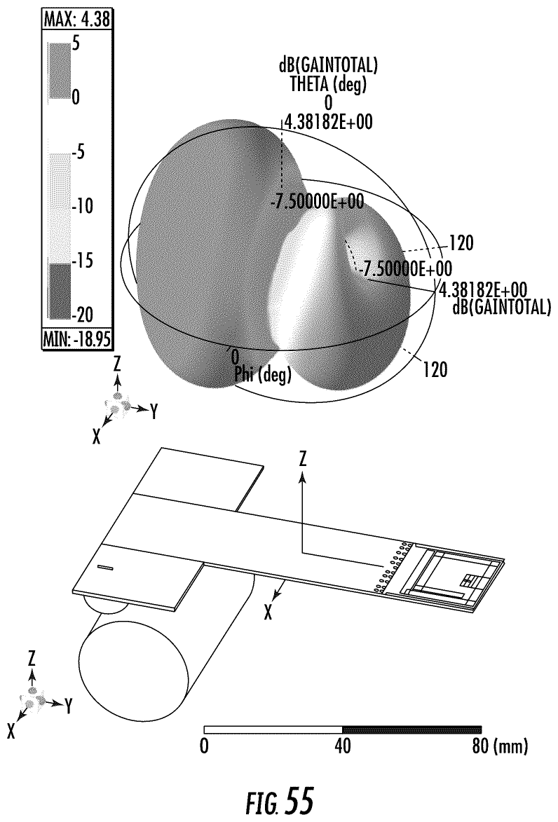

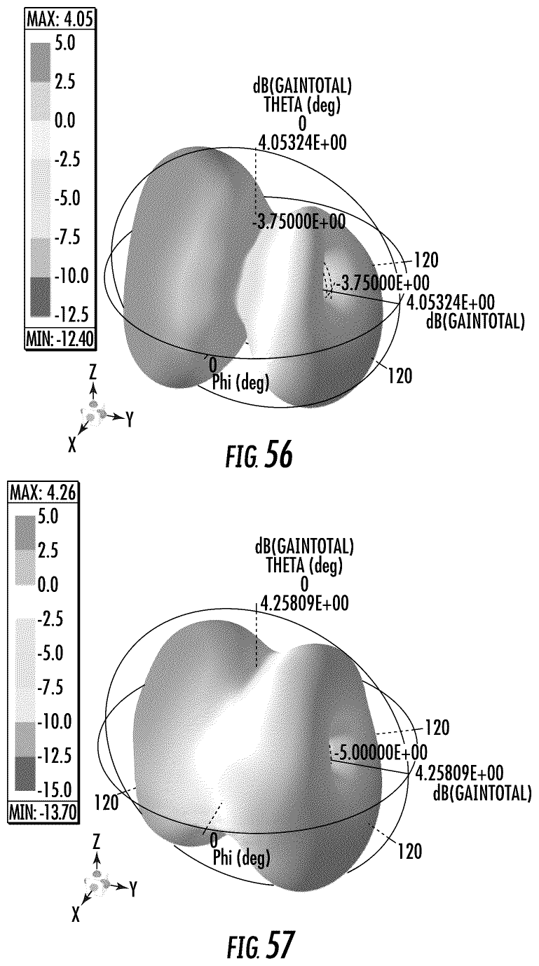

On the upper end of the LTE band, FIG. 55 shows 3D antenna radiation at 1700 MHz. FIG. 56 shows 3D antenna radiation at 1900 MHz. FIG. 57 shows 3D antenna radiation at 2200 MHz. In the upper LTE band, the 3D antenna radiation pattern may be affected by the battery of the system, which influences radiation out of the top of the antenna.

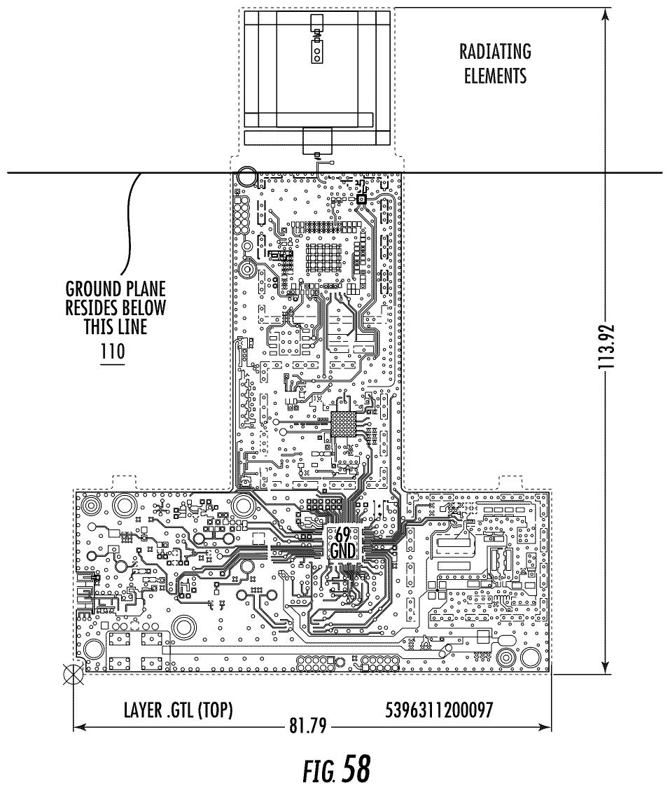

Referring not to FIGS. 58-66, the antenna ground structure in accordance with embodiments of the present inventive concept will be discussed. Specifically, FIGS. 58-66 pertain to the same or substantially similar antenna configuration as that shown and described above with respect to FIGS. 34-37, but it is to be understood that substantially similar effects may be seen when utilizing the antenna embodiment shown and described above with respect to FIGS. 1-8.

The antenna embodiments described previously herein utilize a combination of structures on the PCB. The first are copper deposits on the antenna substrate (e.g., FR4 or other substrate) that form, e.g., the spiral structure and stepped patch structure described above, which will be referred to in the discussion below as the antenna “radiator.” The second are copper deposits residing on a substrate, but positioned below the two structures described above (i.e., below the antenna radiator). The combination of the copper deposits residing on a substrate positioned below the two structures described above (or any structure variation consisting of a spiral structure and a stepped patch structure positioned above the copper deposits residing on a substrate positioned below these structures) may be referred to as a “ground plane” for the purposes of the following discussion. FIG. 58 illustrates the ground plane of the antenna in accordance with embodiments of the present inventive concept.

The combination of a ground plane and a radiator work together to produce a structure generally referred to as an antenna. The antenna described in the embodiments described herein includes a spiral loaded monopole combined with a stepped patch placed above a ground plane, as shown in FIG. 58.

The ground plane of the antenna embodiments described herein has the following properties:

Length: The length of the ground plane relative to the operating frequency of the antenna is selected such that efficient production of antenna electromagnetic fields are produced.

Width: The width of the ground plan relative to the operating frequency of the antenna is selected such that efficient production of antenna electromagnetic fields are produced.

Width Extension: The antenna shown and described in the embodiments presented herein provides enhanced production of electromagnetic fields due to a width extension provided by an elongated structure at the bottom of the antenna ground plane. This structure combined with the center portion of the antenna ground plane results in a “T”-shaped (i.e., elongated) ground plane, as depicted in FIG. 58. However, it is to be noted that a “T” shaped ground plane is not imperative for the antenna operation, and alternative embodiments in accordance with the present inventive concept need not have a “T” shaped ground plane. For example, in some embodiments, the elongated ground plane could be formed as an “L” shape. The antenna may operate at reduced efficiency if the ground plane is not “T” shaped (e.g., a rectangular structure below the antenna radiator). Additionally and/or alternatively, other shapes/configurations could be utilized to widen/elongate the ground plane of the antenna structure residing below the antenna radiator, such as, e.g., a circular, triangular, or other geometric shape(s). Similar to the “T” shaped ground plane described herein, these other shapes could be used to increase the efficiency of the electromagnetic radiation of the antenna.

Radiation: In combination with the radiation structures residing above (e.g., a spiral loaded monopole combined with a stepped patch), the ground plane produces electromagnetic radiation.

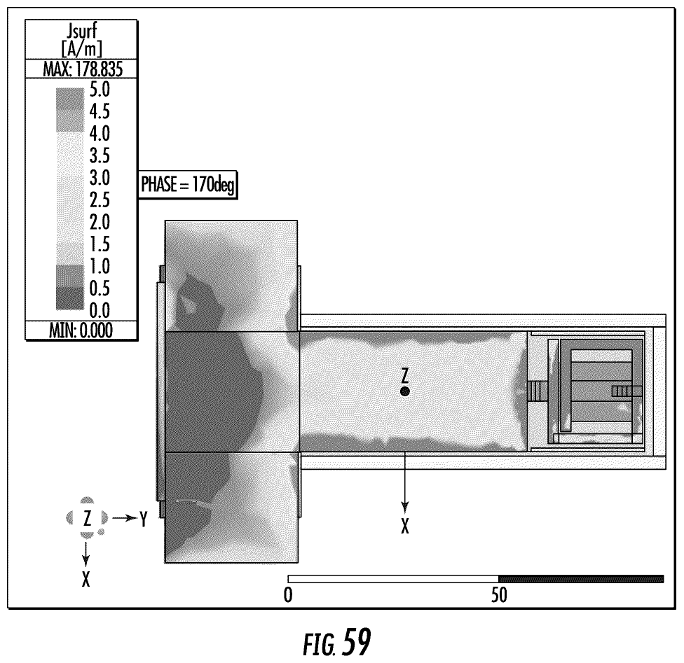

FIGS. 59-66 below are provided in grey scale and the various shades of grey depict values as shown in the legend provided with each of these figures.

FIGS. 59-64 show surface currents produced by the ground plane in conjunction with those of the antenna radiator, which were shown and described above with respect to the embodiments of FIGS. 38-49. However, it is to be understood that similar surface currents would be produced by the ground plane in conjunction with the antenna radiator shown and described with respect to FIGS. 1-8, as well.

The ground plane surface currents produce electromagnetic radiation, and FIGS. 59-64 show the ground plane surface currents at several frequencies over the antenna operating range.

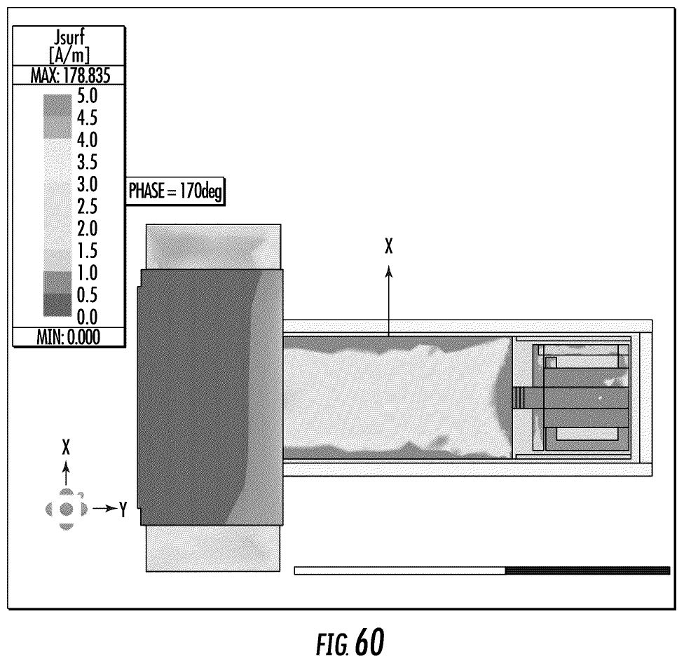

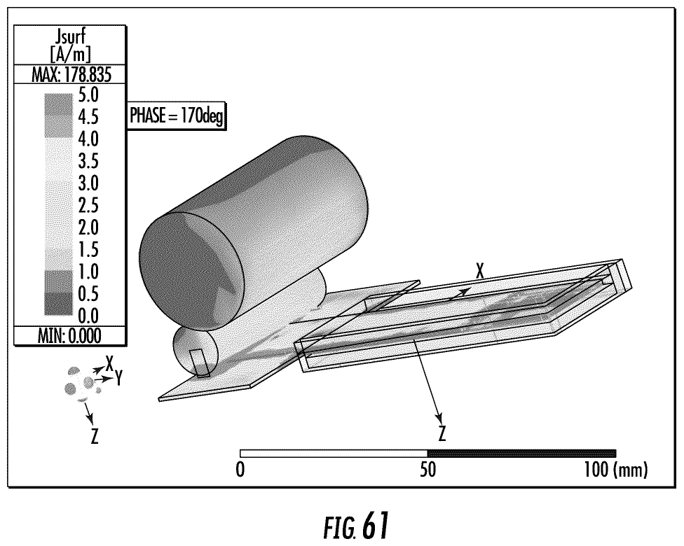

FIGS. 59-61 show the surface currents of the antenna on both the ground plane and antenna radiator at 700 MHZ (i.e., on the lower end of the LTE frequency range), with FIG. 59 being a top view of the PCB and FIGS. 60 and 61 being bottom views of the PCB. Areas highlighted in red show the areas of highest surface currents, with notable current density along the sides of the PCB where the antenna ground plane extends. A battery of the water meter module is visible in FIGS. 60 and 61 by the blue structure atop the elongated portion of the ground plane. Additionally, referring to FIG. 61, high surface currents are noted along the sides of the ground plane and by the slot formed between the hybrid layer capacitor (HLC) and the ground plane.

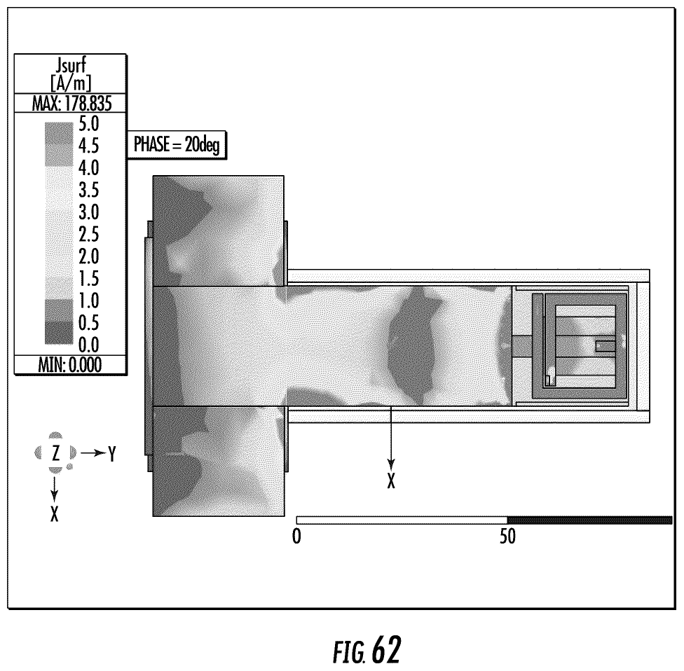

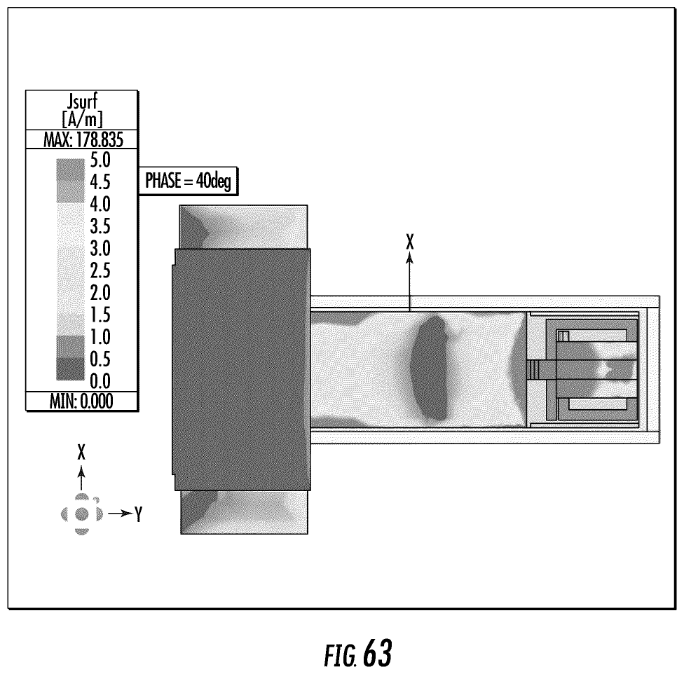

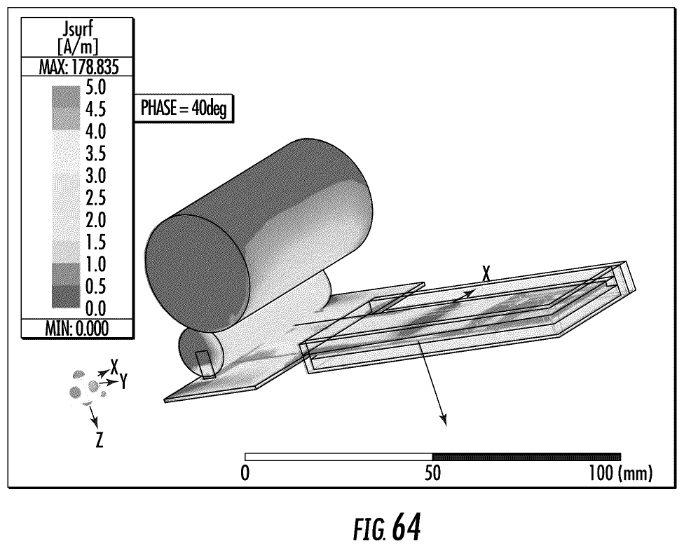

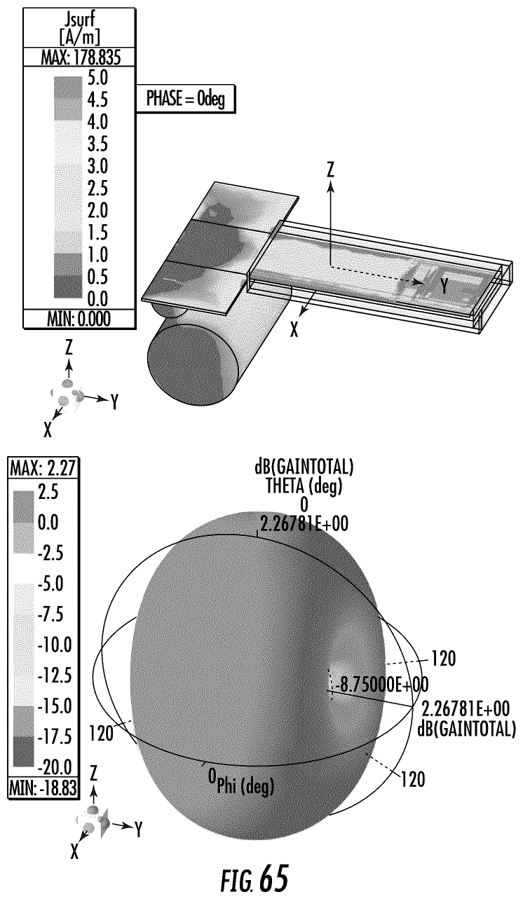

On the other (upper) end of the LTE frequency range, FIGS. 62-64 show the surface currents of the antenna on both the ground plane and antenna radiator at 1900 MHZ. FIG. 62 shows a top view of the PCB, while FIGS. 63 and 64 being bottom views of the PCB. Again, the areas depicted in the legend show the areas of highest surface currents, with notable current density along the sides of the PCB where the antenna ground plane extends shown in FIGS. 62 and 64. The battery of the water meter module is visible in FIGS. 63 and 64 by the blue structure atop the elongated portion of the ground plane. Referring to FIG. 64, high surface currents are noted along the sides of the ground plane and by the slot formed between the hybrid layer capacitor (HLC) and the ground plane.

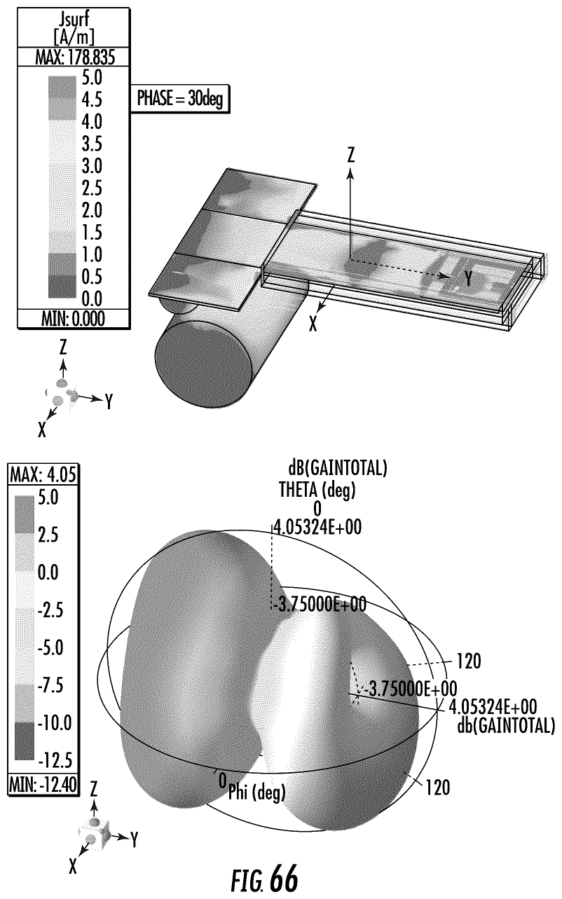

Referring now to FIGS. 65 and 66, the relationship between the antenna surface currents and the surface current efficiency are shown, areas in all plots showing the stronger levels of currents and radiation in accordance with the legend associated with the figures. Specifically, FIG. 65 shows a plot of antenna surface currents and corresponding antenna gain on the same relative planes at 700 MHZ (i.e., on the lower end of the LTE frequency range), while FIG. 66 shows a plot of antenna surface currents and corresponding antenna gain on the same relative planes at 1900 MHZ (i.e., near the upper end of the LTE frequency range). FIG. 66 clearly illustrates the ground plane contribution to the surface current, as evidenced by a null in the antenna pattern that appears at 1900 MHZ, which is not present at 700 MHz shown in FIG. 65. Increased radiation efficiency is notable at the left side of the antenna in FIG. 66, which emanates from the antenna ground plane. The same radiation is generated in FIG. 65 at 700 MHz, but the effect of the null shows this effect more clearly at 1900 MHZ (FIG. 66).

As set forth above, the various embodiments of the present inventive concept relate to a dual-band monopole antenna designed for efficient operation across two distinct frequency bands. The antenna combines spiral and patch radiating elements, along with lumped tuning components, to achieve desired performance, taking into account various enclosures and environments to achieve such performance. In some embodiments, the antenna covers the frequency ranges of 700 MHz to 960 MHz (lower band) and 1700 MHz to 2200 MHz (upper band). The unique design allows for enhanced signal reception and transmission, while maintaining a compact form factor. In some embodiments, the form factor of the monopole antenna allows it to be used with the same or similar enclosures as that currently used in existing water meter modules such as, for example, the Sensus SmartPoint® 520M Pit Set Module.

In some embodiments, the monopole antenna comprises an elongated ground plane, which provides stability and efficient radiation. In some embodiments, the ground plane is further enhanced by the unique “T” shape of the PCB used in the water meter module, resulting in improved performance of the antenna.

The top-loaded monopole includes both spiral and patch radiating elements.

Furthermore, in some embodiments, the antenna includes spiral and patch elements. The spiral elements and elongated ground plane may contribute to the lower frequency range (e.g., 700 MHz to 960 MHz), while the patches, elongated ground plane, and feed line enhance the upper frequency range (1700 MHz to 2200 MHz). The spiral and patch elements are enclosed within a compact area, allowing for efficient use of available space. The coupling between the spiral and patch top loading is optimized for efficient energy transfer.

In some embodiments, a series tuning inductor and capacitor are strategically placed to center the lower frequency range. The tuning capacitor not only improves center frequency alignment but also mitigates resonances that could hinder antenna performance. In some embodiments, a series matching inductor centers the upper frequency range. By incorporating the matching inductor, the antenna's physical length may be reduced, creating additional space for other water meter circuitry on the PCB.

The dual-band monopole antenna described herein offers improved performance, wider bandwidth, and efficient use of space, all while being retrofittable in existing enclosures and other housings, providing for reduced cost and time-to-market. The monopole antenna of the present inventive concept enables reliable communication across both lower and upper LTE bands, making it suitable for various applications.

Additionally, the antenna embodiments described herein include operation in the 880-960 MHz LTE “Band 8” allocation. As noted above, FlexNet® system operation is over a frequency range of 901-960 MHz, while Sensus “TFX” wireless meter reading system(s) may operate over a subset of both of these frequency ranges, namely 902-928 MHz. Accordingly, the antenna operation as disclosed in the embodiments described herein may encompass all three bands, allowing a single antenna configuration to serve various wireless meter reading products utilizing, for example, LTE, FlexNet®, etc.

While the embodiments described above pertain to antennas designed to operate within one or more enclosures such as those shown in FIGS. 9-13, it is to be noted that the antenna embodiments described herein need not necessarily be enclosed in, e.g., an HDPE enclosure or other housing. Indeed, the antennas described herein may be designed to operate over a large range of environments including free air, plastic encapsulation, or other dielectric materials surrounding the antenna, proving the vast utility of the antenna design and not limiting the antenna design to usage in, e.g., water meter module applications.

Although the inventive concept has been described in detail for the purpose of illustration based on what is currently considered to be the most practical and preferred embodiments, it is to be understood that such detail is solely for that purpose and that the inventive concept is not limited to the disclosed embodiments, but, on the contrary, is intended to cover modifications and equivalent arrangements that are within the spirit and scope of the appended claims. For example, it is to be understood that the present inventive concept contemplates that, to the extent possible, one or more features of any embodiment can be combined with one or more features of any other embodiment.

What is claimed is:

1. A dual-band monopole antenna system comprising:
an elongated ground plane;
spiral radiating elements that enable operation a first frequency band; and
patch radiating elements that enable operation in a second frequency band, higher than and distinct from the first frequency band.

2. The dual-band monopole antenna system of claim 1, wherein the first frequency band comprises 700 MHz to 960 Mhz and wherein the second frequency band comprises 1700 MHz to 2200 MHz.

3. The dual-band monopole antenna system of claim 2, where the dual-band monopole system is positioned in a water meter.

4. The dual-band monopole antenna system of claim 1, wherein the elongated ground plane is formed by a printed circuit board.

5. The dual-band monopole antenna system of claim 4:
wherein the printed circuit board is T-shaped; and
wherein the elongated ground plane is enhanced by the T-shaped printed circuit board.

6. The dual-band monopole antenna system of claim 4, wherein the spiral radiating elements and the patch radiating elements are top-loaded on the printed circuit board.

7. The dual-band monopole antenna system of claim 4, further comprising a shared feed point on the printed circuit board for both the first frequency band and the second frequency band.

8. The dual-band monopole antenna system of claim 4, wherein the printed circuit board comprises FR4 fiberglass material.

9. The dual-band monopole antenna system of claim 4, wherein the printed circuit board is a multi-layer printed circuit board.

10. The dual-band monopole antenna system of claim 9, wherein the printed circuit board is a four-layer printed circuit board.

11. The dual-band monopole antenna system of claim 1, further comprising lumped tuning elements that provide impedance matching and resonance suppression.

12. The dual-band monopole antenna system of claim 11, wherein the lumped tuning elements comprise a series tuning inductor and tuning capacitor, wherein the series tuning inductor and tuning capacitor center the first frequency band of operation.

13. The dual-band monopole antenna system of claim 12, wherein the tuning capacitor couples the spiral radiating elements and the patch radiating elements on a printed circuit board.

14. The dual-band monopole antenna system of claim 11:
wherein the lumped tuning elements comprise a series matching inductor; and
wherein the series matching inductor is configured to center the upper frequency band of operation.

15. A water meter module comprising:
an enclosure; and
a dual-band monopole antenna system sized and configured for placement within the enclosure, wherein the dual-band monopole antenna system comprises:
an elongated ground plane;
spiral radiating elements that enable operation in a first frequency band; and
patch radiating elements that enable operation in a second frequency, the second frequency band being separate from and higher than the first frequency band.

16. The water meter module of claim 15, wherein the first frequency band comprises 700 MHz to 960 Mhz and wherein the second frequency band comprises 1700 MHz to 2200 MHz.

17. The water meter module of claim 15, wherein the elongated ground plane is a printed circuit board.

18. The water meter module of claim 17:
wherein the printed circuit board is T-shaped, and
wherein the elongated ground plane is enhanced by the T-shaped printed circuit board.

19. The water meter module of claim 17, further comprising a battery and a hybrid layer capacitor (HLC) coupled to the printed circuit board.

20. The water meter module of claim 19, wherein the battery and HLC are positioned relative to the printed circuit board so as to form part of a ground system of the dual-band monopole antenna system.

21. The water meter module of claim 15, wherein the enclosure is formed of an HDPE material.

22. The water meter module of claim 15, further comprising a plastic housing sized and configured to receive and substantially surround the enclosure.
